(19) United States
(12) Patent Application Publication
(10) Pub. No.: US 2026/0322134 A1
(43) Pub. Date: Oct. 15, 2026

(54) METHOD AND SYSTEM FOR SUPPORTING A SYNCHRONOUS ELECTRICAL GRID

(71) Applicant: Vestesen Hybrid Energy ApS, Hellerup (DK)

(72) Inventors: Thomas Qvist Vestesen, Copenhagen K (DK); Søren Qvist Vestesen, Copenhagen K (DK)

(73) Assignee: Vestesen Hybrid Energy ApS, Hellerup (DK)

(21) Appl. No.: 18/998,771

(22) PCT Filed: Jul. 28, 2023
(86) PCT No.: PCT/DK2023/050193

§ 371 Date: Jan. 27, 2025

(30) Foreign Application Priority Data
Jul. 29, 2022 (DK) PA202270392

(51) Int. Cl. H02J 3/46; H02J 3/0014; H02J 3/007; H02J 3/32; H02J 15/50; H02J 101/20

(52) U.S. Cl. CPC H02J 3/46; H02J 3/00142; H02J 3/007; H02J 3/32; H02J 15/50; H02J 2101/20

(57) ABSTRACT

A power supply system and method for supporting a synchronous electrical grid having coupled thereto one or more grid-forming alternators powered by a steady source of energy, at least one fluctuating source of AC power generated from renewable energy, consumers creating a fluctuating AC power demand, at least one controllable inverter coupled to an electric battery, the power supply system comprising a controller configured to support the synchronous electrical grid through control of the one controllable inverter.

### TECHNICAL FIELD

The disclosure relates to, a method and system for supporting a synchronous electrical grid, in particular a method and system for supporting a synchronous electrical grid in which a substantial portion of the energy is generated by fluctuating renewable energy sources, for example, wind energy, solar energy, hydro energy and/or wave energy.

### BACKGROUND

Synchronous electrical grids are large scale AC grids that typically use large alternators of e.g. a conventional power plant (nuclear, hydro, or fossil powered), i.e. a steady (non-fluctuating), reliable source of energy as the grid-forming component(s) that ensure stable voltage and frequency under all foreseeable operating scenarios, i.e. grid voltage and grid frequency are have traditionally been predominantly controlled/led by these large alternators. Thus, this function has largely been the responsibility of large alternators driven by a turbine or by a prime mover such as an internal combustion engine, the internal combustion engine being powered by a carbon-based fuel. In a synchronous grid all the generator of AC power need to run at the same frequency, and must stay very nearly in phase with each other and the grid. Generation and consumption must be balanced across the entire grid, because energy is consumed as it is produced. Due to the desire to phase out non-renewable energy sources, there is a desire for the ever-increasing portion of the electric power delivered to the synchronous electrical grid to be delivered by the before mentioned fluctuating renewable energy sources. The electrical power output of these renewable energy sources fluctuates due to the fluctuations in the availability of clean energy, e.g. in the form of wind or sunlight. However, a substantial reduction in the amount of electric power delivered by the large alternators of the conventional power plants combined with a substantial increase in the amount of electric power delivered by the fluctuating renewable energy sources, can undermine grid stability and leads to frequency and voltage anomalies and others since the fluctuating sources of power are typically coupled to the synchronous electric grid through an inverter that does not possess rotational inertia whilst simultaneously reducing the size and/or number of large alternators of the conventional power stations reduces the rotational inertia coupled to the grid. Consequently, there is a risk of the synchronous electrical grid in challenging scenarios becoming insufficiently stable due to an insufficient amount of rotational inertia coupled to the grid.

US2019109461 discloses a method for controlling an inverter, and in particular a double stage inverter, for implementing a model of a synchronous generator is provided including implementing a rotor inertia using an intermediate dc-link capacitor without duplicating the emulated inertia in the controller, simulating the rotor speed based on a measured voltage of the dc-link capacitor, while allowing the voltage to change in a defined range, and mapping the changing voltage of the dc-link capacitor into the inverter as an internal frequency. A system for connecting a power generator to a power grid is also provided including a control device for an inverter, the control device implementing a model of a synchronous generator. The control device including a computer processor in electrical communication with a storage device with instructions stored thereon, that when executed on the computer processor, perform the method for controlling an inverter for implementing a model of a synchronous generator.

US2021006072 discloses a method and plant of operating a grid-forming power supply plant based on both a renewable energy, such as based on wind energy, solar energy, hydro energy, wave energy, and a carbon based energy, such as carbon based fuel. The grid includes a power input connection from a renewable power supply system and a power input connection from a carbon fuel engine based generator set. The generator set includes an engine for converting the carbon-based energy into motion energy, a generator, such as an alternator, for converting the motion energy into electrical energy, and a clutch for coupling and uncoupling of the engine with the generator. The system also includes a power buffer, such as a battery, subsystem for providing short term grid-forming capacity and a plant grid-forming controller for controlling grid parameters by means of controlling steps of a method. The plant grid-forming controller includes interaction means for interacting with a control unit of the renewable power supply system, interaction means for interacting with a power buffer control unit, and interaction means for interaction with a control unit of the generator set.

Accordingly, there is a need for a method and system for supporting a synchronous electrical grid that receives a substantial portion of its electrical power from the before mentioned fluctuating renewable energy sources.

### SUMMARY

It is an object to provide a method and system for supporting a synchronous electrical grid and ensuring stable voltage and frequency of the synchronous electrical grid, i.e. allowing the synchronous electrical grid to be operated stably with maximum penetration of the fluctuating renewable energy sources.

The foregoing and other objects are achieved by the features of the independent claims. Further implementation forms are apparent from the dependent claims, the description, and the figures.

According to a first aspect, there is provided a method of supporting a synchronous electrical grid, the synchronous grid having coupled thereto:
at least one fluctuating source of power generated from renewable energy, preferably coupled to the synchronous electrical grid by an inverter,
one of more grid-forming alternators powered by a steady source of energy and operated with rotational inertia to provide phase based inertia active power,
consumers creating a fluctuating power demand,
at least one controllable inverter coupled to an electric battery, and
one or more selectively driven or non-driven alternators each having mechanical rotational inertia, the one or more selectively driven or non-driven alternators being selectively coupled to the synchronous electrical grid in parallel with the at least one controllable inverter,
   the method comprising supporting the synchronous electrical grid by:
operating the at least one controllable inverter with synthetic rotational inertia to provide inverter phase based inertia active power up to a first threshold,
coupling one or more of the selectively driven or non-driven alternators to the synchronous electrical grid for supplying additional phase based inertia active power, when inverter phase based inertia active power is equal or above a first power threshold, and
preferably decoupling one or more of the selectively driven or non-driven alternators from the synchronous electrical grid when one or more of the selectively driven or non-driven alternators are coupled to the synchronous electrical grid and inverter phase based inertia active power is equal to or below a second power threshold, the second power threshold being equal to or lower than the first power threshold.

By always supporting the synchronous electrical grid with synthetic rotational inertia to provide inverter phase based inertia active power up to a maximum with the controllable inverter, combined with selective support of the synchronous electrical grid by supplying phase based inertia active power from rotating mass, only when this is necessary, the synchronous electrical grid can be stabilized despite the relatively low amount of rotational inertia connected to the grid, and without unnecessary causing losses through selectively driven or nondriven alternators being coupled continuously to the synchronous electrical grid. Thus, the above-mentioned problem is overcome or at least reduced, thereby allowing increased deployment of fluctuating sources of power generated from renewable energy and increased penetration of renewable energy.

In a possible implementation form of the first aspect, the method comprises:
measuring grid frequency, preferably at the terminals of the at least one controllable inverter,
coupling one or more of the selectively driven or non-driven alternators to the synchronous electrical grid when frequency anomaly of the measured grid frequency is above a first frequency anomaly threshold, and
preferably decoupling one or more of the selectively driven or non-driven alternators from the synchronous electrical grid when one or more of the selectively driven or non-driven alternators are coupled to the synchronous electrical grid and frequency anomaly of the measured grid frequency is or below a second frequency anomaly threshold, the second frequency anomaly being lower than the first frequency anomaly threshold.

In a possible implementation form of the first aspect, the one of more grid-forming alternators are used as master controller for obtaining desired grid frequency and voltage.

In a possible implementation form of the first aspect, the method comprises:
measuring grid voltage, preferably at the terminals of the at least one controllable inverter,
coupling one or more of the selectively driven or non-driven alternators to the synchronous electrical grid when voltage anomaly of the measured grid voltage is above a first voltage anomaly threshold, and
preferably decoupling one or more of the selectively driven or non-driven alternators from the synchronous electrical grid when one or more of the selectively driven or non-driven alternators are coupled to the synchronous electrical grid and voltage anomaly of the measured grid voltage is below a second voltage anomaly threshold, the second voltage anomaly threshold being equal to or lower than the first voltage anomaly.

In a possible implementation form of the first aspect, the method comprises:
determining short circuit ratio or level, preferably at the terminals of the controllable inverter,
coupling one or more of the selectively driven or non-driven alternators to the synchronous electrical grid when the determined short circuit or level is above a first short circuit ratio or level threshold, and
preferably decoupling one or more of the selectively driven or non-driven alternators from the synchronous electrical grid when one or more of the selectively driven or non-driven alternators are coupled to the synchronous electrical grid and the determined short circuit ratio or level is below a second short circuit ratio or level threshold, the second short circuit ratio or level threshold being equal to or lower than the first short circuit ratio threshold or level.

In a possible implementation form of the first aspect, the method comprises:
coupling one or more of the selectively driven or non-driven alternators to the synchronous electrical grid when reactive power supplied by the controllable inverter is above a first reactive power threshold, and
preferably decoupling one or more of the selectively driven or non-driven alternators from the synchronous electrical grid when one or more of the selectively driven or non-driven alternators are coupled to the synchronous electrical grid and the reactive power supplied by the controllable inverter is below a second reactive power threshold, the second reactive power threshold being equal to or lower than the first reactive power threshold.

In a possible implementation form of the first aspect, the controllable inverter is configured to support a desired grid frequency:
by supplying power from the electric battery through the at least one controllable inverter to the synchronous electrical grid when the measured grid frequency is below a desired grid frequency by more than a first lower margin, and
by withdrawing power through the at least one controllable inverter from the synchronous electrical grid to the electric battery when the measured grid frequency is above the desired grid frequency by more than a first upper margin.

In a possible implementation form of the first aspect, the controllable inverter comprises one or more of a grid following mode of operation, a grid supporting mode of operation, a grid-forming mode of operation, the method comprising operating the controllable inverter in the grid following mode of operation, the grid supporting mode of operation, or the grid-forming mode of operation, and preferably comprising switching to the grid-forming mode when there is not enough grid-forming capacity coupled to the synchronous electrical grid for ensuring said stable desired grid voltage and frequency or when one or more of the one or more selectively driven or non-driven alternators are coupled to the synchronous electrical grid.

In a possible implementation form of the first aspect, the inertia and/or capacity of the one or more selectively driven or non-driven alternators is for at least one of the one or more selectively driven or non-driven alternators different from the inertia and/or capacity of the other of the one or more selectively driven or non-driven alternators, the method preferably comprising selecting to couple or decouple one of the one or more selectively driven or non-driven alternators with an inertia and/or capacity to obtain a desired change in the inertia and/or capacity coupled to the synchronous electrical grid.

In a possible implementation form of the first aspect, the method comprises: supporting the magnitude and angle of the grid voltage at the terminals of the controllable inverter with the controllable inverter operating in its grid-forming mode.

In a possible implementation form of the first aspect, the method comprises: supporting the magnitude and angle of the grid voltage with the selectively driven or non-driven alternators coupled to the synchronous electrical grid.

In a possible implementation form of the first aspect, the method comprises: controlling the power injected by the controllable inverter, preferably comprising estimating the fundamental frequency phasor of the grid voltage, so as to generate the instantaneous value of the current reference and the voltage reference.

In a possible implementation form of the first aspect, the method comprises: bringing the one or more selectively driven or non-driven alternators up to synchronous speed using an electric motor M or an internal combustion engine before coupling the one or more selectively driven or non-driven driven alternators to the synchronous electrical grid, preferably shortly before coupling the one or more selectively driven or non-driven alternators to the synchronous electrical grid.

In a possible implementation form of the first aspect, the method comprises: increasing the amount of power supplied to the synchronous electrical grid by the battery through the controllable inverter according to a defined slope, preferably substantially proportionally, with increasing deviation of the measured grid frequency below a first lower margin and vice versa, and increasing the amount of power withdrawn from the grid by the battery according to a defined slope, preferably proportionally with increasing deviation of the measured grid frequency above the first upper margin.

In a possible implementation form of the first aspect, the system comprises a controllable resistive load-bank coupled to the synchronous electrical grid, the resistive load-bank having a capacity to withdraw a variable amount of power from the synchronous electrical grid, and the resistive load-bank preferably having a capacity to change the amount of energy withdrawn from the synchronous electrical grid faster than the battery can change the amount of power withdrawn from the synchronous electrical grid, and
the method comprises reducing power withdrawn from the synchronous electrical grid by the resistive load-bank when the measured grid frequency is below the desired grid frequency by more than a second lower margin, the second lower margin preferably being smaller than the first lower margin, and increasing power withdrawn from the synchronous electrical grid by the resistive load-bank when the measured grid frequency is above the desired grid frequency by more than a second upper margin, the second upper margin preferably being equal to or smaller than the first upper margin, preferably comprising the resistive load-bank allowing grid frequency to vary within the second lower and the second upper margin.

In a possible implementation form of the first aspect, the method comprises: increasing the amount of power withdrawn from the synchronous electrical grid by the resistive load-bank according to a defined slope, preferably proportionally, with increasing deviation of the grid frequency above the second upper margin and vice versa, and
decreasing the amount of power withdrawn from the synchronous electrical grid by the resistive load-bank according to a defined slope, preferably proportionally, with increasing deviation of the grid frequency below the second lower margin.

In a possible implementation form of the first aspect, the method comprises: coupling one or more of the one or more selectively driven or non-driven alternators to the synchronous electric grid when one or more of:
frequency anomalies are above a frequency anomaly threshold,
voltage anomalies are above a voltage anomaly threshold,
power supplied by the at least one controllable inverter exceeds a power supply threshold,
power absorbed by the at least one controllable inverter exceeds a power absorption threshold,
when one or more of the one of more grid-forming alternators decouple from the synchronous electrical grid,
when power demand by the consumers increases with a speed above a speed increase threshold,
when power supply by the at least one fluctuating source of power decreases with a speed above a speed decrease threshold.

In a possible implementation form of the first aspect, the method comprises: determining or measuring reactive power drawn from the controllable inverter, reducing reactive power drawn from the at least one controllable inverter, and covering reactive power with the one or more selectively driven or non-driven alternators when reactive power is above a reactive power threshold.

In a possible implementation form of the first aspect, the at least one selectively driven alternator is selectively operably couplable to an internal combustion engine.

In a possible implementation form of the first aspect, the internal combustion engine is operated on hydrogen or a mixture of hydrogen and another fuel, the internal combustion engine being coupled to a hydrogen supply system, the hydrogen supply system comprising a hydrogen storage unit,
at least one hydrogen generating unit coupled to the synchronous grid, the method comprising:
   powering the at least one hydrogen generating unit with electric power from the at least one fluctuating source of electric power, when electric power generated by the at least one fluctuating source of power generated from renewable energy and the one of more alternators powered by a non-fluctuating source of energy
      exceeds actual consumer electric power demand and preferably simultaneously hydrogen storage capacity is available in the hydrogen storage unit, for generating hydrogen with the at least one hydrogen generating unit,
storing hydrogen generated by the at least one hydrogen generating unit in the hydrogen storage unit,
generating electric power with the at least one selectively driven alternator by combusting hydrogen from the hydrogen storage unit or a mixture of hydrogen from the hydrogen storage unit and another fuel in the internal combustion engine by operably coupling the internal combustion engine to the alternator and driving the alternator with the internal combustion engine, preferably when actual electric power generated by the at least one fluctuating source of electric power, is less than the actual consumer electric power demand and simultaneously the amount of hydrogen in the hydrogen storage unit is above a hydrogen amount threshold.

In a possible implementation form of the first aspect, the controllable inverter is controlled to cover active power, not reactive power and reactive power is covered by coupling in one or more of the one or more selectively driven or non-driven alternators to the synchronous electrical grid.

In a possible implementation form of the first aspect, the deadband +S2 Hz to −S2 of the energy bank can be chosen according to operating conditions to be within the deadband +S3 to −S3 of the controllable inverter, for reducing wear and tear on the battery and also to dampen large power variations on the synchronous electrical grid.

In a possible implementation form of the first aspect, the deadband +S2 Hz to −S2 of the energy bank can be chosen or adjusted according to operating conditions to be outside the deadband +S3 to −S3 of the controllable inverter, in particular, to assist to dampen large power variations on the grid.

In a possible implementation form of the first aspect, the deadband of the energy bank can be chosen according to operating conditions to start within the deadband +S3 to −S3 of the controllable inverter, for reducing wear and tear on the battery from small power variations and then at larger power variations to be outside the deadband +S3 to −S3 of the controllable inverter to benefit from both of above strategies.

In a possible implementation form of the first aspect, the controller is configured to operate the energy bank to put in load steps when the kW charge level into the battery exceeds the charge level limit for the battery. Preferably this possible implementation form takes into account that the limit of the charge level into the battery is a function of the charge level of the battery.

In a possible implementation form of the first aspect, the controller is configured to put in load steps for the energy bank when power from the at least one fluctuating source of power generated from renewable energy is reduced as a consequence of the charge level limit for the battery.

According to a second aspect, there is provided an energy supply system for coupling to a synchronous electrical grid, the system comprising:
at least one fluctuating source of power generated from renewable energy, preferably coupled to the synchronous electrical grid by an inverter,
one of more grid-forming alternators powered by a steady source of energy and operated with rotational inertia to provide phase based inertia active power,
consumers coupled to the synchronous electrical grid creating a fluctuating power demand, at least one controllable inverter coupled to an electric battery and to the synchronous electrical grid,
one or more selectively driven or non-driven alternators, each having mechanical rotational inertia coupled to the synchronous electrical grid, the one or more selectively driven or non-driven alternators being selectively coupled to the synchronous electrical grid in parallel with the at least one controllable inverter, and
a controller configured to:
   operate the at least one controllable inverter with synthetic rotational inertia to provide inverter phase based inertia active power up to a first threshold,
coupling one or more of the selectively driven or non-driven alternators to the synchronous electrical grid for supplying additional phase based inertia active power, when inverter phase based inertia active power is equal or above a first power threshold, and
preferably decoupling one or more of the selectively driven or non-driven alternators from the synchronous electrical grid when one or more of the selectively driven or non-driven alternators are coupled to the synchronous electrical grid and inverter phase based inertia active power is equal to or below a second power threshold, the second power threshold being equal to or lower than the first power threshold.

In a possible implementation form of the second aspect, the one of more grid-forming alternators are used as master controller to obtain desired grid frequency and voltage.

According to a third aspect, there is provided a method for supporting a synchronous electrical grid, the synchronous electrical grid having coupled thereto:
at least one fluctuating source of power generated from renewable energy,
one of more grid-forming alternators powered by a steady source of energy the one of more grid-forming alternators being configured to establish grid frequency and voltage with the one of more grid-forming alternators as master controller to obtain a desired grid frequency and voltage,
consumers creating a fluctuating power demand, and
at least one controllable inverter coupled to an electric battery,
   the method comprising:
establishing grid frequency and voltage with the one of more alternators as master controller to obtain a desired grid frequency and voltage,
operating the at least one fluctuating source of power as a slave to the synchronous electrical grid,
measuring grid frequency of the synchronous electrical grid, preferably at the terminals of the controllable inverter,
supporting grid frequency by:
   supplying power from the electric battery through the at least one controllable inverter to the synchronous and grid when the measured grid frequency is below the desired grid frequency by more than a first lower margin, and
   withdrawing power through the at least one controllable inverter from the synchronous electrical grid to the electric battery when the measured grid frequency is above the desired grid frequency by more than a first upper margin.

The control method, system infrastructure, and system configuration allow for a hybrid energy generating system coupled to a synchronous electrical grid that adjusts with a fast and robust response using each component within their most optimal operation area supported by their own dynamic in combination with total system dynamic.

By both:
operating the at least one fluctuating source of power as a slave to the grid and supporting grid frequency with the at least one controllable inverter to support a desired grid frequency by:
   supplying power from the electric battery through the controllable inverter to the grid when the measured grid frequency is below the desired grid frequency by more than a first lower margin, and withdrawing power through the controllable inverter from the grid to the electric battery when the measured grid frequency is above the desired grid frequency by more than a first upper margin is required,
      it becomes possible to react fast to deviations of the frequency using the at least one inverter as the grid frequency supporting element grid and ensure a stable grid frequency.

The method allows for operating with maximum continuous renewable energy penetration.

In a possible implementation form of the third aspect, the controllable inverter as a grid-forming mode and at least either a grid following mode or a grid supporting mode.

In a possible implementation form of the third aspect, the method comprises switching from either the grid following mode or the grid supporting mode to the grid-forming mode when the measured grid frequency deviates more from the desired grid frequency than a frequency deviation threshold.

In a possible implementation form of the third aspect, at least one selectively driven alternator is selectively coupled to the synchronous electrical grid and wherein the at least one selectively driven alternator is selectively driven by an internal combustion engine, and wherein the selectively driven alternator is operated with a fixed load or power setting when the selectively driven alternator is driven by the internal combustion engine, preferably through a fixed power setting of the internal combustion engine, the selectively driven alternator preferably being operated with a fixed load or power setting for a predetermined length of time, with the fixed load or power setting changing periodically.

In a possible implementation form of the third aspect, the controllable inverter allows grid frequency to vary within the first lower margin and the first upper margin.

In a possible implementation form of the third aspect, the method comprises increasing the amount of power supplied to the grid by the battery according to a defined slope, preferably substantially proportionally, with increasing deviation of the measured grid frequency below the first lower margin and vice versa, and increasing the amount of power withdrawn from the grid by the battery according to a defined slope, preferably proportionally with increasing deviation of the measured grid frequency above the first upper threshold and vice versa.

In a possible implementation form of the third aspect, the method comprises a controllable energy bank resistive load-bank coupled to the grid, the energy bank having a capacity to withdraw a variable amount of power from the grid, and the energy bank preferably having a capacity to change the amount of energy withdrawn from the grid faster than the battery can change the amount of power withdrawn from the grid, and
reducing power withdrawn from the grid by the energy bank when the measured grid frequency is below the desired grid frequency by more than a second lower margin, the second lower margin preferably being smaller than the first lower margin, and increasing power withdrawn from the grid by the energy bank when the measured grid frequency is above the desired grid frequency by more than a second upper margin, the second upper margin preferably being smaller than the first upper margin, preferably comprising the energy bank allowing grid frequency to vary within the second lower and the second upper margin.

In a possible implementation form of the third aspect, the second lower margin is larger than the first lower margin, and the second upper margin is larger than the first upper margin.

In a possible implementation form of the third aspect, the energy bank engages before the controllable inverter assisting in adjusting the grid frequency.

In a possible implementation form of the third aspect, the method comprises increasing the amount of power withdrawn from the grid by the energy bank according to a defined slope, preferably proportionally, with increasing deviation of the grid frequency above the second upper threshold and vice versa, and decreasing the amount of power withdrawn from the grid by the energy bank according to a defined slope, preferably proportionally, with increasing deviation of the grid frequency below the second lower threshold and vice versa.

In a possible implementation form of the third aspect, the grid has selectively coupled thereto, in parallel with the controllable inverter, at least one driven or non-driven alternator for stabilizing grid frequency fluctuations, for adding inertia, and for improving grid voltage stability, comprising controlling reactive power, inertia and/or short-circuit effect in the grid by selectively coupling and decoupling the at least one or more selectively driven or non-driven alternators to the grid in parallel with the controllable inverter, the selectively driven alternators preferably being driven by an internal combustion engine, the alternator preferably being operably coupled to a flywheel to increase inertia.

In a possible implementation form of the third aspect, the method comprises measuring reactive power drawn from the controllable inverter, and coupling at least one driven or non-driven alternator to the grid in parallel with the controllable inverter when reactive power drawn from the controllable inverter exceeds a first reactive power threshold, preferably coupling one or more additional driven or non-driven alternator to the grid in parallel with the controllable inverter when reactive power drawn from the controllable inverter remains above the first reactive power threshold.

In a possible implementation form of the third aspect, the method comprises keeping alternators online connected to the busbar for stabilizing the grid even though the internal combustion engines are disengaged from the alternators by a clutch system and stopped.

In a possible implementation form of the third aspect, the method comprises coupling one or more additional driven or non-driven alternators to the grid in parallel with the controllable inverter when wind turbines or other electric drives coupled to the grid are started up, preferably upon detection or notification of the turbines or other electric drives starting up.

In a possible implementation form of the third aspect, the method comprises measuring active power and reactive power, minimizing active power drawn from the controllable inverter, and covering reactive power with the at least one driven or non-driven alternator when reactive power is above a reactive power threshold, and preferably covering reactive power with the at least one fluctuating source of power when reactive power is below a predetermined threshold.

In a possible implementation form of the third aspect, the grid has selectively coupled thereto, in parallel with the controllable inverter, at least one alternator driven by an internal combustion engine, the method comprising starting increasing engine power production according to a defined slope when the measured grid frequency is below the desired grid frequency by more than a third lower margin, the third lower margin being smaller than the second lower margin, and decreasing engine power according to a defined slope when the measured grid frequency exceeds the desired grid frequency by more than a third upper margin, the third upper margin being smaller than the second upper margin, preferably comprising the driven alternator allowing grid frequency to vary within the third lower and the third upper margin.

In a possible implementation form of the third aspect, the method comprises controlling a battery charge level within a nominated control band, comprising for a grid having the energy bank coupled thereto, increasing power withdrawn from the grid by the energy bank when the battery charge level reaches the upper limit of the control band and/or for a grid having the generator driven by an internal combustion engine coupled thereto, starting and/or increasing engine power when the battery charge level reaches a lower limit of the control band.

In a possible implementation form of the third aspect, the method comprises charging the battery by withdrawing energy from the grid when surplus power is available from the fluctuating source of power.

In a possible implementation form of the third aspect, the method comprises supporting grid voltage with the controllable inverter to obtain a desired grid voltage.

In a possible implementation form of the third aspect, the renewable energy generation systems are slaves to the controllable inverter and follow control signals from a charge level band in the battery coupled to the controllable inverter.

In a possible implementation form of the third aspect, the inverter battery is able to take total load on the consumer side with the battery having sufficient fast capability for the energy balancing functionality of the battery inverter system.

In a possible implementation form of the third aspect, the energy bank is frequency controlled.

In a possible implementation form of the third aspect, a continuous load on the energy bank is used for heating purposes.

In a possible implementation form of the third aspect, an additional storage solution is provided, and the surplus energy is the capturing into the additional storage solution instead of reducing power output of the one or more fluctuating sources of power from renewable energy.

In a possible implementation form of the third aspect, the additional storage feeds storage energy back into the system via the control grid-forming battery inverter system or by its own electrical energy generation system.

In a possible implementation form of the third aspect, the battery system is charged with surplus renewable energy.

In a possible implementation form of the third aspect, the grid frequency is measured with a high number of impulses per second, for example, more than 2250 impulses per second, preferably more than 4500 impulses per second, allowing a fast reading of the frequency trend variations, hence allowing for fast adjustments of the frequency by the controllable inverter.

In a possible implementation form of the third aspect, the voltage at the busbar is sensed and compared with the desired reference value, and the voltage difference between them is sent to the proportional plus integral controller.

In a possible implementation form of the third aspect, a sine wave having amplitude 1 and reference frequency is multiplied to generate a reference signal, and this reference signal produces pulse width modulated pulses to switch on/off a voltage source inverter.

According to a fourth aspect, there is provided an energy supply system for coupling to a synchronous electrical grid, the system comprising:
at least one fluctuating source of power generated from renewable energy coupled to the synchronous electrical grid,
one of more grid-forming alternators powered by a steady source of energy that establishes a desired grid frequency, the one of more grid-forming alternators being coupled to the synchronous electrical grid and configured to establish grid frequency and voltage with the one of more grid-forming alternators as master controller to obtain a desired grid frequency and voltage,
consumers coupled to the synchronous electrical grid creating a fluctuating power demand, and
at least one controllable inverter coupled to an electric battery and to the synchronous electrical grid, and
a controller configured to:
   operate the at least one fluctuating source of power as a slave to the synchronous electrical grid,
   measure grid frequency of the synchronous electrical grid, preferably at the terminals of the controllable inverter,
   support grid frequency by
      supplying power from the electric battery through the at least one controllable inverter to the synchronous electrical grid when the measured grid frequency is below the desired grid frequency by more than a first lower margin, and
      withdrawing power through the at least one controllable inverter from the synchronous electrical grid to the electric battery when the measured grid frequency is above the desired grid frequency by more than a first upper margin.

According to a fifth aspect, there is provided a method for supporting a synchronous electrical grid, the synchronous electrical grid having coupled thereto:
one of more alternators powered by a non-fluctuating source of energy,
at least one fluctuating source of electric power generated from renewable energy for supplying electric power to the synchronous electrical grid,
consumers creating a fluctuating consumer electric power demand on the synchronous electrical grid,
at least one selectively driven alternator, the selectively driven alternator being selectively operably couplable to an internal combustion engine operated on hydrogen or a mixture of hydrogen and another fuel, the internal combustion engine being coupled to a hydrogen supply system, the hydrogen supply system comprising a hydrogen storage unit,
at least one hydrogen generating unit coupled to the electrical grid and/or to the at least one fluctuating source of electric power,
   the method comprising:
keeping the selectively driven alternator coupled to the synchronous electrical grid and online regardless of the alternator being coupled to the internal combustion engine,
powering the at least one hydrogen generating unit with electric power from the at least one fluctuating source of electric power when, and preferably only when actual electric power generated by the at least one fluctuating source of electric power exceeds actual consumer electric power demand and simultaneously hydrogen storage capacity is available in the hydrogen storage unit, for generating hydrogen with the at least one hydrogen generating unit,
storing hydrogen generated by the at least one hydrogen generating unit in the hydrogen storage unit,
generating electric power with the at least one selectively driven alternator by combusting hydrogen from the hydrogen storage unit or a mixture of hydrogen from the hydrogen storage unit and another fuel in the internal combustion engine by operably coupling the internal combustion engine to the alternator and driving the alternator with the internal combustion engine, when, and preferably only when actual electric power generated by the at least one fluctuating source of electric power is less than the actual consumer electric power demand and simultaneously the amount of hydrogen in the hydrogen storage unit is above a hydrogen amount threshold.

The combination of the distinguishing features allows for a synchronous electric grid that uses a hydrogen generation unit that is powered exclusively by renewable energy, that has fluctuating power demand from multiple consumers, and that uses the stored hydrogen for power generation only when there is a deficit of renewable energy, and at the same time provides for a stable synchronous electric grid, despite the fluctuating supply of power from renewable energy, fluctuating demand of power from the consumers and a switching operation mode between using power for hydrogen generation to generate power by combusting hydrogen. The always online selectively driven alternators provide for frequency stability both when hydrogen is generated using power and when hydrogen is combusted to generate power. The synchronized alternators will support the grid with inertia from the rotating mass, reactive power, and fault current if needed.

By providing a hydrogen generation system that is powered by renewable energy sources connected to the synchronous electric grid, and by storing the hydrogen generated with the hydrogen generation system and they generating power using an internal combustion driven alternator by combusting the stored hydrogen, when, the sources of renewable energy are not sufficient to meet the consumer demand on the synchronous electric grid, and synchronous electrical grid is provided that is capable of bridging periods where insufficient direct power from renewable energy sources is available, without needing to turn to none renewable energy sources.

In a possible implementation form of the fifth aspect, the at least one selectively driven alternator is operated with a fixed load or power setting when the selectively driven alternator is driven by the internal combustion engine, preferably through a fixed power setting of the internal combustion engine, the selectively driven alternator 34 preferably being operated with a fixed load or power setting for a predetermined length of time, with the fixed load or power setting changing periodically.

In a possible implementation form of the fifth aspect, the internal combustion engine operates on a mixture of hydrogen and a liquid fuel, such as fuel oil pilot oil. The fuel can be supplied to the internal combustion engine separately from the hydrogen. The fuel oil can be supplied as a pilot oil, i.e. as an oil that ensures or assists ignition. Preferably, the fuel is injected at high pressure from fuel valves and the injection of the fuel oil can be used timed for timed ignition.

In a possible implementation form of the fifth aspect, the internal combustion engine is a compression ignited engine, i.e. an engine operating to the Diesel principle, and fuel is injected when the pistons are at or near top dead center.

In a possible interpretation of the fifth aspect, the internal combustion engine operates according to the Otto principle, and a mixture of fuel and charging air is compressed during the stroke of the piston from bottom dead center to top dead center.

In a possible implementation of the fifth aspect, the mixture of hydrogen from the hydrogen storage unit and another fuel comprises a mixture of hydrogen from the hydrogen storage unit and one or more of petroleum gas, natural gas, syngas, biogas, ammonia. Biogas is a mixture of gases, primarily consisting of methane, carbon dioxide and hydrogen sulphide, produced from raw materials such as agricultural waste, manure, municipal waste, plant material, sewage, green waste, and food waste.

In a possible implementation form of the fifth aspect, an electric battery is connected to the grid by an inverter, comprising generating power with the at least one selectively driven alternator by combusting hydrogen from the hydrogen storage unit or a mixture of hydrogen from the hydrogen storage unit and another fuel in the internal combustion engine, when the charge level of the electric battery is below a first battery charge level threshold, preferably comprising delaying powering the at least one hydrogen generation unit, until the electrical battery has reached the first battery charge level threshold.

In a possible implementation form of the fifth aspect, the controller is configured to ramp up and down hydrogen production with the generation unit as a function, preferably a proportional correlation, of the availability of actual surplus electric power generated by the at least one fluctuating source of electric power wherein actual surplus electric power is defined as the amount to which the actual power generated by the at least one fluctuating source of electric power exceeds the actual consumer power demand.

In a possible implementation form of the fifth aspect, exclusively hydrogen from the hydrogen storage unit is combusted in the internal combustion engine, though covering the possibility to use e.g. fuel oil as ignition liquid pilot oil.

In a possible implementation form of the fifth aspect, hydrogen from the hydrogen storage unit is combusted in the internal combustion engine, as a mixture of hydrogen from the hydrogen storage unit and other fuels such as fuel oil, or fuel gas, or hydrogen from another source.

In a possible implementation form of the fifth aspect, the controller is configured to ramp up and down hydrogen production with the hydrogen generation unit as a function, preferably a proportional correlation, of the frequency of the grid.

In a possible implementation form of the fifth aspect, the method comprises pressuring hydrogen generated by the hydrogen generating unit using a high-pressure pump driven by an electric drive motor and comprising powering the electric drive motor with electric power generated by the at least one fluctuating source of electric power.

In a possible implementation form of the fifth aspect, the method comprises determining the actual consumer power demand, determining the actual electric power generated by at least one fluctuating source of electric power, and preferably comparing the actual consumer power demand with the actual electric power generated by the at least one fluctuating source of electric power.

In a possible implementation form of the fifth aspect, the at least one fluctuating source of electric power comprises a photovoltaic unit coupled to an inverter for inverting DC power generated by the photovoltaic unit to power, the inverter preferably being coupled to a busbar.

In a possible implementation form of the fifth aspect, the at least one fluctuating source of electric power comprises at least one wind turbine, the wind turbine preferably being directly driving a wind turbine driven alternator coupled to a busbar.

In a possible implementation form of the fifth aspect, the hydrogen generating unit comprises an electrolysis unit, the electrolysis unit being supplied with electric power to one or more of: the photovoltaic unit, the inverter, the wind turbine, the busbar.

In a possible implementation form of the fifth aspect, the fluctuating source of electric power the hydrogen generating unit and the selectively driven alternator, the selectively driven alternator and/or the inverter are connected to a busbar.

In a possible implementation form of the fifth aspect, a clutch system between the internal combustion engine and the selectively driven alternator, the clutch system preferably being controlled by the controller.

In a possible implementation form of the fifth aspect, the selectively driven alternator is coupled to the grid and kept online regardless of the alternator being coupled to the internal combustion engine or not.

In a possible implementation form of the fifth aspect, the controller is configured to clutch-in the internal combustion engine when the internal combustion engine is at synchronous rpm with the selectively driven alternator.

In a possible implementation form of the fifth aspect, the method comprises generating power with the at least one selectively driven alternator by combusting fuel other than hydrogen from storage unit in the internal combustion engine, when actual electric power generated by the at least one fluctuating source of electric power is less than the consumer power demand and simultaneously the amount of hydrogen in the hydrogen storage unit is below a hydrogen amount threshold.

In a possible implementation form of the fifth aspect, the least one selectively driven alternator being selectively operably couplable to an internal combustion engine operated on a fuel other than hydrogen from the storage unit, the method comprising generating power with the at least one selectively driven alternator by combusting fuel other than hydrogen from the storage unit in the internal combustion engine, when actual electric power generated by the at least one fluctuating source of electric power is less than the consumer power demand and simultaneously the amount of hydrogen in the hydrogen storage unit is below a hydrogen amount threshold.

In a possible implementation form of the fifth aspect, the internal combustion engine is configured to be pre-pressuring and heated for optimal operation in lower loads and for having fast response and startup.

In a possible implementation form of the fifth aspect, the alternator is equipped with an air duct system for ventilation air connecting an internal combustion engine filter housing.

In a possible implementation form of the fifth aspect, the internal combustion engine is equipped with a separate pre-pressuring system for pressurizing an internal combustion engine filter housing.

In a possible implementation form of the fifth aspect, the control of the heating of the internal combustion engine the air cooler system is separated from the engine and controlled by temperature.

In a possible implementation form of the fifth aspect, the control of the heating of the internal combustion engine is equipped with a pre-heating system.

In a possible implementation form of the fifth aspect, a fuel cell is coupled to the grid via an inverter, the fuel cell being coupled to the hydrogen storage unit, comprising generating power with the fuel cell by converting hydrogen from the hydrogen storage unit into DC power and converting the DC power into power with the inverter when the actual electric power generated by the at least one fluctuating source of electric power is less than the consumer power demand and simultaneously the amount of hydrogen in the hydrogen storage unit is above a hydrogen amount threshold, the hydrogen amount threshold being greater than or equal to 0.

In a possible implementation form of the fifth aspect, the method comprises:
operating the at least one fluctuating source of power as a slave to the grid,
measuring grid frequency,
supporting grid frequency with a controllable inverter to obtain a desired grid frequency,
supplying power from an electric battery through the controllable inverter to the grid when the measured grid frequency is below the desired grid frequency by more than a first lower margin, and
withdrawing power through the controllable inverter from the grid to the electric battery when the measured grid frequency is above the desired grid frequency by more than a second first upper margin.

In a possible implementation form of the fifth aspect, the method comprises increasing power production with the fuel cell and the inverter according to a defined slope when the measured grid frequency is below the desired grid frequency by more than a fourth lower margin, decreasing power production with the fuel cell and the inverter according to a defined slope when the measured grid frequency exceeds the desired grid frequency by more than a fourth upper margin.

In a possible implementation form of the fifth aspect, the system comprises an electric battery coupled to the grid by an inverter, and the method comprises powering the at least one hydrogen generating unit with power from the at least one fluctuating source of electric power when, and preferably only when, actual electric power generated by the at least one fluctuating source of electric power exceeds actual consumer power demand and battery charge level is above an upper charge level set point and simultaneously hydrogen storage capacity is available in the hydrogen storage unit and battery charge level of the electric battery is above a battery charge threshold.

According to a sixth aspect, there is provided an energy supply system for coupling to a synchronous electrical grid, the energy supply system comprising:
one of more alternators powered by a non-fluctuating source of energy coupled to the synchronous electrical grid,
at least one fluctuating source of electric power generated from renewable energy coupled to the synchronous electrical grid for supplying electric power to the synchronous electrical grid,
consumers coupled to the synchronous electrical grid creating a fluctuating consumer electric power demand on the synchronous electrical grid,
at least one selectively driven alternator coupled to the synchronous electrical grid, the selectively driven alternator being selectively operably couplable to an internal combustion engine operated on hydrogen or a mixture of hydrogen and another fuel, the internal combustion engine being coupled to a hydrogen supply system, the hydrogen supply system comprising a hydrogen storage unit,
at least one hydrogen generating unit coupled to the electrical grid and/or to the at least one fluctuating source of electric power,
   the method comprising:
keeping the selectively driven alternator coupled to the synchronous electrical grid and online regardless of the alternator being coupled to the internal combustion engine,
powering the at least one hydrogen generating unit with electric power from the at least one fluctuating source of electric power when, and preferably only when actual electric power generated by the at least one fluctuating source of electric power exceeds actual consumer electric power demand and simultaneously hydrogen storage capacity is available in the hydrogen storage unit, for generating hydrogen with the at least one hydrogen generating unit,
storing hydrogen generated by the at least one hydrogen generating unit in the hydrogen storage unit,
generating electric power with the at least one selectively storage unit or a mixture of hydrogen from the hydrogen storage unit and another fuel in the internal combustion engine by operably coupling the internal combustion engine to the alternator and driving the alternator with the internal combustion engine, when, and preferably only when actual electric power generated by the at least one fluctuating source of electric power is less than the actual consumer electric power demand and simultaneously the amount of hydrogen in the hydrogen storage unit is above a hydrogen amount threshold.

According to a seventh aspect, there is provided a method of supporting a synchronous electrical grid that is required to have a stable desired grid voltage and frequency, the synchronous electrical grid having coupled thereto:
at least one fluctuating source of power generated from renewable energy, preferably coupled to the synchronous electrical grid by an inverter,
consumers creating a fluctuating power demand,
one or more controllable inverters, the one or more controllable inverters being coupled to an electric battery, and
the least the two controllable inverters being configured to be switchable between a grid-forming mode and a grid supporting mode, wherein the at least the two controllable inverters establish the desired grid frequency and voltage in the grid-forming mode, and wherein the one or more controllable inverters support the desired grid frequency and voltage in the supporting mode, the method comprising:
   operating the one or more controllable inverters 20 per default in grid supporting mode,
   detecting whether there is enough grid-forming capacity coupled to the synchronous electrical grid for ensuring stable desired grid voltage and frequency,
   switching at least one of the one or more controllable inverters to grid-forming mode when there is not enough grid-forming capacity coupled to the synchronous electrical grid for ensuring the stable desired grid voltage and frequency.

According to a possible implementation form of the seventh aspect, the method comprises measuring grid frequency and determining that there is not enough grid-forming capacity coupled to the synchronous electrical grid when the measured grid frequency deviates more from the desired grid frequency by more than a predetermined frequency deviation threshold.

According to a possible implementation form of the seventh aspect, the method comprises the one or more controllable inverters regulating their output voltage and frequency in the grid-forming mode.

According to a possible implementation form of the seventh aspect, the one or more controllable inverters support the synchronous electrical grid by supplying active and reactive power in the grid supporting mode.

According to an eighth aspect, there is provided a system for supporting a synchronous electrical grid, the synchronous electrical grid being required to have a stable desired grid voltage and frequency, the system comprising:
at least one fluctuating source of power generated from renewable energy coupled to the synchronous electrical grid, preferably coupled to the synchronous electrical grid by an inverter,
consumers creating a fluctuating power demand coupled to the synchronous electrical grid,
one or more controllable inverters, the one or more controllable inverters 20 being coupled to an electric battery and to the synchronous electrical grid, and
the least the two controllable inverters being configured to be switchable between a grid-forming mode and a grid supporting mode, wherein the at least the two controllable inverters establish the desired grid frequency and voltage in the grid-forming mode, and wherein the one or more controllable inverters support the desired grid frequency and voltage in the supporting mode, and
a controller configured to:
   operate the one or more controllable inverters per default in grid supporting mode,
   detect whether there is enough grid-forming capacity coupled to the synchronous electrical grid for ensuring stable desired grid voltage and frequency,
   switch at least one of the one or more controllable inverters to grid-forming mode when there is not enough grid-forming capacity coupled to the synchronous electrical grid for ensuring the stable desired grid voltage and frequency.

According to a possible implementation of the eighth aspect, the least the two controllable inverters are connected to the synchronous electrical grid in parallel, each of the one or more controllable inverters being preferably connected to an individual battery for each of the one or more controllable inverters.

According to a possible implementation of the eighth aspect, the system is configured to measure grid frequency and determine that there is not enough grid-forming capacity coupled to the synchronous electrical grid when the measured grid frequency deviates more from the desired grid frequency by more than a predetermined frequency deviation threshold.

According to a possible implementation of the eighth aspect, the one or more controllable inverters are configured regulating their output voltage and frequency in the grid-forming mode.

According to a possible implementation of the eighth aspect, the one or more controllable inverters are configured to support the synchronous electrical grid by supplying active and reactive power in the grid supporting mode.

According to a ninth aspect, there is provided a method for operating an AC electrical grid, the AC electrical grid having coupled thereto:
at least one fluctuating source of AC electric power generated from renewable energy for supplying AC electric power to the AC electrical grid,
consumers creating a fluctuating consumer AC electric power demand on the AC electrical grid,
an electrolysis unit of a hydrogen generating unit the electrolysis unit having a capacity to withdraw a variable amount of power from the AC electrical grid,
   controlling grid frequency with the grid-forming controllable inverter 20 as master controller to obtain a desired grid frequency,
measuring grid frequency and voltage of the grid,
supplying power from the electric battery through the grid-forming controllable inverter to the AC electrical grid when the measured grid frequency is below the desired grid frequency by more than a first lower margin,
withdrawing power through the grid-forming controllable inverter from the AC electrical grid to the electric battery when the measured grid frequency is above the desired grid frequency by more than a first upper margin, and
reducing power withdrawn from the AC electrical grid by the electrolysis unit when the measured grid frequency is below the desired grid frequency by more than a fifth lower margin, and increasing power withdrawn from the electrical AC electrical grid by the electrolysis unit when the measured grid frequency is above the desired grid frequency by more than a fifth upper margin, preferably comprising the electrolysis unit allowing grid frequency to vary within the fifth lower and the fifth upper margin.

According to a possible implementation of the ninth aspect, the method comprises increasing the amount of power withdrawn from the AC electrical grid by the electrolysis unit according to a defined slope, preferably proportionally, with increasing deviation of the grid frequency above the second upper threshold and vice versa, and decreasing the amount of power withdrawn from the AC electrical grid by the electrolysis unit according to a defined slope, preferably proportionally, with increasing deviation of the grid frequency below the second lower threshold.

According to a possible implementation of the ninth aspect, the AC electrical grid has coupled thereto a controllable resistive load-bank, the resistive load-bank having a capacity to withdraw a variable amount of power from the AC electrical grid, the method comprising:
reducing power withdrawn from the AC electrical grid by the resistive load-bank when the measured grid frequency is below the desired grid frequency by more than a second lower margin, the second lower margin being larger than the fifth lower margin, and increasing power withdrawn from the AC electrical grid by the resistive load-bank when the measured grid frequency is above the desired grid frequency by a second upper margin, the second upper margin being smaller than the fifth upper margin, preferably comprising the resistive load-bank allowing grid frequency to vary within the second lower and the second upper margin.

According to a tenth aspect, there is provided a system for supporting an AC electrical grid, the system comprising:
at least one fluctuating source of AC electric power generated from renewable energy coupled to the AC electrical grid for supplying AC electric power to the AC electrical grid,
consumers coupled to the AC electrical grid creating a fluctuating consumer AC electric power demand on the AC electrical grid,
an electrolysis unit of a hydrogen generating unit coupled to the AC electrical grid, the electrolysis unit having a capacity to withdraw a variable amount of power from the AC electrical grid,
   a controller configured for controlling grid frequency with the grid-forming controllable inverter 20 as master controller to obtain a desired grid frequency,
   the controller being informed of grid frequency and voltage of the AC electrical grid,
   the controller being configured to:
supply power from the electric battery through the grid-forming controllable inverter the grid when the measured grid frequency is below the desired grid frequency by more than a first lower margin,
withdraw power through the grid-forming controllable inverter from the grid to the electric battery when the measured grid frequency is above the desired grid frequency by more than a first upper margin, and
reduce power withdrawn from the grid by the electrolysis unit when the measured grid frequency is below the desired grid frequency by more than a fifth lower margin, and
increase power withdrawn from the grid by the electrolysis unit when the measured grid frequency is above the desired grid frequency by more than a fifth upper margin, preferably comprising the electrolysis unit allowing grid frequency to vary within the fifth lower and the fifth upper margin.

According to a possible implementation form of the tenth aspect, the controller is configured to increase the amount of power withdrawn from the AC electrical grid by the electrolysis unit according to a defined slope, preferably proportionally, with increasing deviation of the grid frequency above the second upper threshold and vice versa, and decrease the amount of power withdrawn from the AC electrical grid by the electrolysis unit according to a defined slope, preferably proportionally, with increasing deviation of the grid frequency below the second lower threshold.

According to a possible implementation form of the tenth aspect, the AC electrical grid has coupled thereto a controllable resistive load-bank, the resistive load-bank having a capacity to withdraw a variable amount of power from the AC electrical grid, the controller being configured to:
reduce power withdrawn from the AC electrical grid by the resistive load-bank when the measured grid frequency is below the desired grid frequency by more than a second lower margin, the second lower margin being larger than the fifth lower margin, and increase power withdrawn from the AC electrical grid by the resistive load-bank when the measured grid frequency is above the desired grid frequency by a second upper margin, the second upper margin being smaller than the fifth upper margin, preferably comprising the resistive load-bank allowing grid frequency to vary within the second lower and the second upper margin.

According to an eleventh aspect, there is provided a method for supporting an isolated AC grid, the isolated AC grid having coupled thereto:
at least one fluctuating source of power generated from renewable energy,
consumers creating a fluctuating power demand, and
at least one controllable inverter coupled to an electric battery,
at least one selectively driven alternator that is selectively coupled to the isolated AC grid,
   the method comprising:
operating the at least one fluctuating source of power as a slave to the isolated AC grid,
measuring grid frequency of the isolated AC grid, preferably at the terminals of the controllable inverter,
supporting grid frequency by:
   supplying power from the electric battery through the at least one controllable inverter to the isolated AC grid when the measured grid frequency is below the desired grid frequency by more than a first lower margin, and
      withdrawing power through the at least one controllable inverter from the isolated AC grid to the electric battery when the measured grid frequency is above the desired grid frequency by more than a first upper margin,
coupling the at least one selectively driven alternator to the isolated AC grid and driving the selectively driven alternator with an internal combustion engine, and
operating the selectively driven alternator with a fixed load or power setting, preferably through a fixed power setting of the internal combustion engine, the selectively driven alternator preferably being operated with a fixed load or power setting for a predetermined length of time, with the fixed load or power setting changing periodically.

According to an twelfth aspect, there is an energy supply system for coupling to an isolated AC grid, the energy supply system comprising:
at least one fluctuating source of power generated from renewable energy coupled to the isolated AC grid,
consumers coupled to the isolated AC grid creating a fluctuating power demand, and
at least one controllable inverter coupled to an electric battery and to the isolated AC grid,
at least one selectively driven alternator that is selectively coupled to the isolated AC grid, and
a controller configured to:
   operate the at least one fluctuating source of power as a slave to the isolated AC grid,
   measure grid frequency of the isolated AC grid, preferably at the terminals of the controllable inverter,
   support grid frequency by:
      supplying power from the electric battery through the at least one controllable inverter to isolated AC grid when the measured grid frequency is below the desired grid frequency by more than a first lower margin, and
      withdrawing power through the at least one controllable inverter from the isolated AC grid to the electric battery when the measured grid frequency is above the desired grid frequency by more than a first upper margin,
      coupling the at least one selectively driven alternator to the isolated AC grid and driving the selectively driven alternator with an internal combustion engine, and
      operating the selectively driven alternator with a fixed load or power setting, preferably through a fixed power setting of the internal combustion engine, the selectively driven alternator preferably being operated with a fixed load or power setting for a predetermined length of time, with the fixed load or power setting changing periodically.

These and other aspects will be apparent from the embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is a diagrammatic overview of a system comprising an embodiment of an energy supply system,

FIG. 2 is a graph illustrating a first control principle,

FIG. 3 is a graph illustrating a second control principle,

FIG. 4 is a diagrammatic illustration of a controllable inverter that is used in the system of FIG. 1,

FIG. 5 is a diagrammatic illustration of a hydrogen generation, storage and supply system associated with the energy supply system of FIG. 1,

FIG. 6 is a diagrammatic illustration of the fuel generation, storage and supply system associated with the energy supply system of FIG. 1, and

FIG. 7 is a diagrammatic overview of a system comprising another embodiment of an energy supply system, and

FIG. 8 is a diagrammatic overview of a system comprising yet another embodiment of an energy supply system.

### DETAILED DESCRIPTION

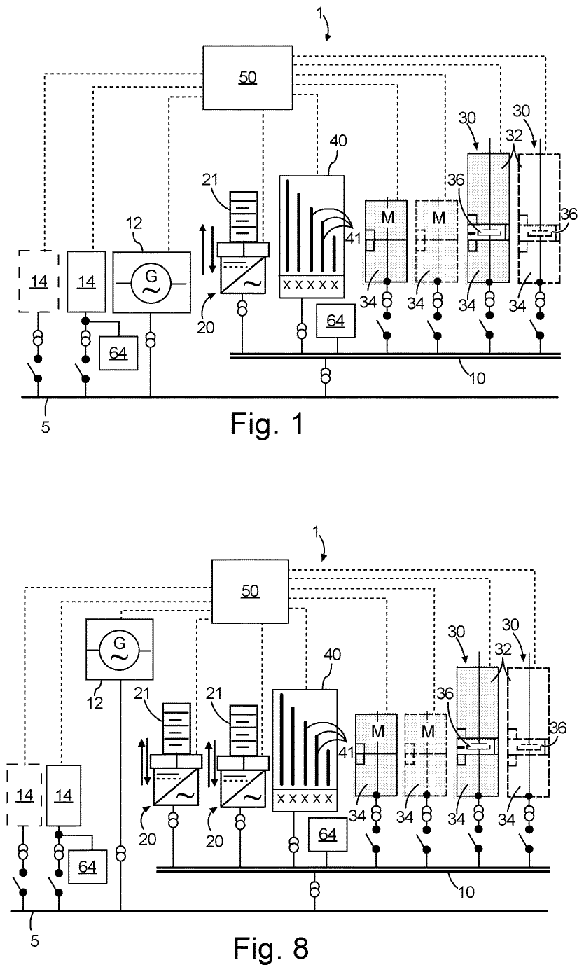

FIG. 1 illustrates a power supply system 1 for supporting a synchronous electrical grid 5, e.g. a connected or wide area synchronous electrical grid 5. One or more grid-forming alternators 12 powered by a steady source of energy and operated with rotational inertia to provide phase based inertia active power are connected to a synchronous electrical grid 5. The one or more grid-forming alternators 12

[symbol]

FIG. 1 shows both required and optional elements of the power supply system 1. The synchronous grid 5, is supported with electrical power by the power supply system 1, which is connected to the synchronous electrical grid 5 via a busbar 10. The synchronous electrical grid 5 connects to a large number of consumers of electrical power (not shown), which create a fluctuating power demand on the synchronous electrical grid 5.

A controller 50, controls the operation of the power supply system 1. The power supply system 1 controls one or more fluctuating sources of power 14 generated from renewable energy. The fluctuating sources of power 14 may comprise one or more of wind turbines, wave energy generators, tidal energy generators, solar energy collectors, each coupled to the synchronous grid 5 via an inverter and optionally via a busbar if the fluctuating sources of power 14 are grouped.

The fluctuating sources of power 14 receive a control signal, for e.g. stop, start, and control of max power output, e.g. via a signal line, from the controller 50, and the controller 50 receives information about the operation of the fluctuating sources of power 14.

At least one grid-forming alternator 12 powered by a steady source of energy is coupled to the grid to be a master grid-forming component. The grid-forming alternators 12 can be used to establish grid frequency and voltage when initiating operation of the grid, and the grid-forming alternators 12 are the main or dominating asset on the synchronous grid 5 determining grid frequency and voltage. Mainly due to their large rotational inertia, the grid-forming alternators 12 ensures that the grid 5 operates with a required voltage Vref and frequency e.g. 230 V and 50 Hz or 110 V and 60 Hz. The grid-forming alternator 12 has a relatively large rotational inertia and is operated to provide substantial phase based inertia active power.

The energy supply system 1 comprises at least one controllable inverter 20 coupled to a rechargeable electric battery 21, so that the controllable inverter 20 can, depending on need, receive electric power from the battery 21 and store electric power in the battery 21. Several controllable inverters 20 can be arranged in parallel to obtain the required capacity and/or redundancy. The battery 21 can be of any suitable type comprising secondary cells, with a suitable capacity to store electrical charge and a sufficiently high C-rate. In an embodiment, the battery 21 is assisted by power from the fuel cell for the supply of electric power to the controllable inverter 20. Several batteries 21 can be arranged in parallel to obtain the required capacity and/or redundancy.

The controllable inverter 20 is coupled to the controller 50, e.g. via a signal line, and the operation of the controllable inverter 20 is controlled by the controller 50 to support the synchronous electrical grid 5. In an embodiment, the controller 50 is an integral part of the controllable inverter 20.

The inverter control structure preferably incorporates a voltage regulator and its frequency can be auto-generated or the grid frequency at the inverter terminals is measured and compared with the desired frequency. The controllable inverter 20 has a grid-forming mode, i.e. it can act as if it is responsible for producing and maintaining voltage and frequency at the busbar 10. In an embodiment, the controllable inverter 20 has a grid-forming mode and a grid supporting mode and can switch between these two modes. In yet another embodiment the controllable inverter 20 has a grid-forming mode, grid supporting mode and a grid following mode and can switch between these three modes.

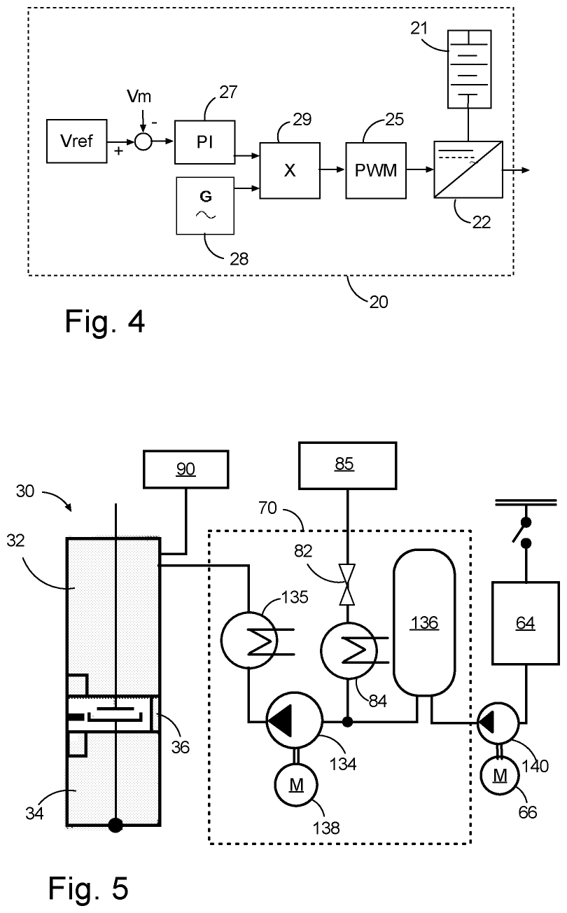

In the grid-forming mode, the controllable inverter 20 ensures within its operational capacity that the synchronous electrical grid operates with a required voltage Vref and frequency e.g. 230 V and 50 Hz or 110 V and 60 Hz and this is in part achieved by the inverter control. The diagram of the inverter control scheme is shown in FIG. 4. The voltage at the busbar 10 is sensed Vm and compared with the desired reference value Vref and the difference between them is sent to proportional plus integral PI controller 27. A sine wave having amplitude 1 and frequency 50 Hz or other desired value from a sine wave generator 28 is multiplied in a multiplier 29 to generate the reference signal. This reference signal is sent to a pulse width modulator 25 to produce pulse width modulated PWM pulses to switch on/off a voltage source inverter 20. An LC filter (not shown) is arranged in the controllable inverter 20 in order to eliminate the high frequency harmonics from the output voltage.

In the grid-forming mode the controllable inverter 20 regulates its output voltage and frequency. On the other hand, in grid supporting mode the controllable inverter 20 supports the grid with active and reactive power.

The energy supply system 1 comprises one or more selectively driven or non-driven (SD/ND) alternators 34, each having mechanical rotational inertia from rotational mass. The one or more SD/ND alternators 34 are coupled to the synchronous electrical grid 5 in parallel with the at least one controllable inverter 20. The at least one SD/ND alternator 34 stabilizes the grid frequency fluctuations by adding rotational inertia and improving grid voltage stability. Non-driven alternators are alternators that are rotating synchronously with the grid and are kept spinning by the grid and form a condenser. These not driven alternators 34 are soft started by an electric drive motor (not shown) that is coupled to the non-driven alternator. After bringing the non-driven alternator 34 up to synchronous speed the electric drive motor is no longer powered and rotates in unison with the non-driven alternator 34 to increase its rotational inertia, alternatively and in case a clutch is fitted between the non-driven alternator 34 and the electrical drive motor, the electrical drive motor is clutched out and stopped. Selectively-driven alternators 34 are coupled to an internal combustion engine 32 and can be selectively engaged and disengaged from such internal combustion engine 32 under control of the controller 50, e.g. by a clutch 36, i.e. the selectively driven alternator 34 can be part of a hybrid generator set.

These SD/ND alternators 34 are controlled by the controller 50 e.g. via signal lines. The alternator 34 is in an embodiment selectively driven by an internal combustion engine 32. This so-called hybrid genset system 30 with a genset of the standard type equipped with clutch system 36 of standard type. Additional inertia mass may be added to the alternators 34, for example in the form of the flywheel (not shown), to increase the kinetic energy effect. The selectively driven alternator 34 is connected to an internal combustion engine 32 on a common bedframe for engine power backup function. When alternator 34 is online rotating in sync with the grid 5, engine start-up is fast as the internal combustion engine 32 only starts up itself and does not have to accelerate the alternator rotor from 0 rpm to synchronous rpm as alternator 34 is already connected and online. Engine clutch-in is performed at synchronous rpm between alternator 34 and internal combustion engine 32. The alternator 34 may be equipped with an air duct system for ventilation air for connecting to the nominated engine filter housing as described in EP0745186. The internal combustion engine 32 may be hybrid equipped for optimal operation in lower loads and for having fast response which may include the engine cooler system separated from the internal combustion engine as described in EP0745186.

The controller 50 is configured to operate the at least one controllable inverter 20 with synthetic rotational inertia to provide inverter phase based inertia active power up to a first power threshold. The first power threshold is below a maximum active power output of the controllable inverter 20, to avoid overloading the controllable inverter 20.

The one or more of the s SD/ND alternators 34 are not coupled to the grid 5 per default; then one or more of the SD/ND alternators 34 are only coupled to the grid 5 when needed to stabilize the grid 5 to avoid parasitic losses on the grid 5 and wear of the one or more of the SD/ND alternators 34.

The controller 50 is configured to:
couple one or more of the SD/ND alternators 34 to the synchronous electrical grid 5 for supplying additional phase based inertia active power, when inverter phase based inertia active power is equal to or above the first power threshold, and
decouple one or more of the SD/ND alternators 34 from the synchronous electrical grid 5 when one or more of the SD/ND alternators 34 are coupled to the synchronous electrical grid 5 and inverter phase based inertia active power is equal to or below a second power threshold. The second power threshold is equal to or lower than the first power threshold.

By coupling one or more SD/ND alternators 34 onto the synchronous electrical grid 5, these alternators 34 start providing phase based inertia reactive power, thereby reducing the inverter phase based inertia active power, ensuring that the amount of inverter phase based inertia active power does not exceed the maximum power that the controllable inverter can deliver and thus ensuring that sufficient phase based inertia reactive power is available for the synchronous electrical grid 5. Preferably, one alternator 34 is coupled to the synchronous electrical grid 5 at a time, and thus, when a plurality of alternators 34 is coupled to the grid this is preferably done one at the time, i.e. sequentially. By decoupling one or more SD/ND alternators 34 once inverter phase based inertia active power is below the second power threshold, it is ensured that the selectively driven or non-driven alternators 34 do not stay online longer than necessary, thereby avoiding parasitic drag and wear on the SD/ND alternators 34. The difference in magnitude between the first and second power threshold should be chosen to avoid unnecessary frequent at short interval coupling and decoupling of the SD/ND alternators 34, i.e. to avoid SD/ND alternator 34 to be repetitively coupled to and decoupled and can be determined through simple trial and error.

In an embodiment, the controller 50 is also configured to:
measure grid frequency, preferably at the terminals of the at least one controllable inverter 20,
couple one or more of the SD/ND alternators 34 to the synchronous electrical grid 5 when frequency anomaly of the measured grid frequency is above a first frequency anomaly threshold, and
decouple one or more of the SD/ND alternators 34 from the synchronous electrical grid 5 when one or more of the SD/ND alternators 34 are coupled to the synchronous electrical grid 5 and frequency anomaly of the measured grid frequency is or below a second frequency anomaly threshold, the second frequency anomaly being lower than the first frequency anomaly threshold.

By engaging one more SD/ND alternators 34 upon detection of frequency anomalies exceeding a first frequency anomaly threshold, frequency anomalies on the synchronous electric grid 5 are reduced. When the measured frequency anomalies are below a second frequency and only threshold one or more SD/ND alternators 34 are coupled from the synchronous electric grid, preferably sequentially if more than one SD/ND alternator 34 is decoupled. The magnitude of the acceptable frequency anomalies be determined in accordance with industry standards or by simple trial and error. Similarly, the difference in magnitude between the first and second frequency anomaly threshold can be determined by simple trial and error.

In an embodiment, the controller 50 is also configured to:
measure grid voltage, preferably at the terminals of the at least one controllable inverter 20,
couple one or more of the SD/ND alternators 34 to the synchronous electrical grid 5 when voltage anomaly of the measured grid voltage is above a first voltage anomaly threshold, and
decouple one or more of the SD/ND alternators 34 from the synchronous electrical grid 5 when one or more of the SD/ND alternators 34 are coupled to the synchronous electrical grid 5 and voltage anomaly of the measured grid voltage is below a second voltage anomaly threshold, the second voltage anomaly threshold being equal to or lower than the first voltage anomaly.

Accordingly, grid voltage is supported by one or more SD/ND alternators 34 only when this is required. The voltage anomaly thresholds can be determined in accordance with industry standards or by a simple trial and error. The difference between the first and second voltage and only threshold can similarly be determined by simple trial and error.

In an embodiment, the controller 50 is also configured to:
determine short circuit ratio or level, preferably at the terminals of the controllable inverter 20,
couple one or more of the SD/ND alternators 34 to the synchronous electrical grid 5 when the determined short circuit or level is above a first short circuit ratio or level threshold, and
decouple one or more of the SD/ND alternators 34 from the synchronous electrical grid 5 when one or more of the SD/ND alternators 34 are coupled to the synchronous electrical grid 5 and the determined short circuit ratio or level is below a second short circuit ratio or level threshold, the second short circuit ratio or level threshold being equal to or lower than the first short circuit ratio threshold or level.

Accordingly, support against short circuit on the synchronous electrical grid 5 is provided by one or more SD/ND alternators 34 only when required.

In an embodiment, the controller 50 is also configured to:
couple one or more of the SD/ND alternators 34 to the synchronous electrical grid 5 when reactive power supplied by the controllable inverter 20 is above a first reactive power threshold, and
decouple one or more of the SD/ND alternators 34 from the synchronous electrical grid 5 when one or more of the SD/ND alternators 34 are coupled to the synchronous electrical grid 5 and the reactive power supplied by the controllable inverter 20 is below a second reactive power threshold, the second reactive power threshold being equal to or lower than the first reactive power threshold.

Accordingly, overload of the controllable inverter through excessive supply of reactive power is avoided. The difference in magnitude between the first and second reactive power threshold can be determined through simple trial and error.

The controllable inverter 20 is configured to support a desired grid frequency by supplying power from the electric battery 21 through the at least one controllable inverter 20 to the synchronous electrical grid 5 when the measured grid frequency is below a desired grid frequency by more than a first lower margin, and by withdrawing power through the at least one controllable inverter 20 from the synchronous electrical grid 5 to the electric battery 21 when the measured grid frequency is above the desired grid frequency by more than a first upper margin.

In an embodiment, the controllable inverter 20 comprises one or more of: a grid following mode of operation, a grid supporting mode of operation, a grid-forming mode of operation. The controllable inverter 20 is operated in either the grid following mode of operation, the grid supporting mode of operation, or the grid-forming mode of operation and can be switched by the controller 50 to the grid-forming mode when one or more of the one or more SD/ND alternators 34 are coupled to the synchronous electrical grid 5.

In an embodiment, the inertia and/or capacity of the one or more SD/ND alternators 34 is for at least one of the one or more SD/ND alternators 34 different from the inertia and/or capacity of the other of the one or more SD/ND alternators 34. The controller 50 can be configured to select to couple or decouple one of the one or more SD/ND alternators 34 with an inertia and/or capacity to obtain a desired change in the inertia and/or capacity coupled to the synchronous electrical grid 5. Thus, a smaller capacity or inertia and the/as the alternator 34 can be coupled to the synchronous electrical grid 5 when there is only a relatively small need for capacity/inertia to be connected to the synchronous electrical grid and a larger capacity/inertia SD/and the alternator 34 can be coupled to the synchronous electrical grid 5 when there is a larger need for capacity as inertia to be coupled to the synchronous electrical grid 5.

In an embodiment, the controller 50 is configured to support the magnitude and angle of the grid voltage at the terminals of the controllable inverter 20 with the controllable inverter 20 operating in its grid-forming mode.

When the controllable inverter 20 is operating in its grid support mode, the controllable inverter 20 controls the power injected by the controllable inverter 20, by estimating the fundamental frequency phasor of the grid voltage, so as to generate the instantaneous value of the current reference and the voltage reference.

Preferably, the one or more SD/ND alternators 34 up to synchronous speed using an electric motor M or an internal combustion engine 32 before coupling the one or more SD/ND driven alternators 34 to the synchronous electrical grid 5, preferably shortly before coupling the one or more SD/ND alternators 34 to the synchronous electrical grid 5.

In case of use of hybrid generator sets 30 and engine capacity 32 is activated, the engine 32 is started up on its own and coupled to the alternator 34 when the engine is at synchronous speed.

In an embodiment, the controller 50 is configured to increase the amount of power supplied to the synchronous electrical grid 5 by the battery 21 through the controllable inverter 20 according to a defined slope, preferably substantially proportionally, with increasing deviation of the measured grid frequency below a first lower margin and vice versa, and increasing the amount of power withdrawn from the grid by the battery 21 according to a defined slope, preferably proportionally with increasing deviation of the measured grid frequency above the first upper margin.

A controllable energy bank resistive load-bank 40 is coupled to the grid. The energy bank 40 is controlled by the controller 50, e.g. via a signal line. The energy bank 40 has a capacity to withdraw a variable amount of power from the grid, and the energy bank 40 preferably has a capacity to change the amount of energy withdrawn from the grid faster than the battery 21 can change the amount of power withdrawn from the grid. The energy bank 40 is a system that is coupled to the grid via the busbar 10 to provide rapid changes of resistive load on the grid. The energy bank 40 provides fast regulation with load steps in a binary range. In an embodiment, the energy bank 40 is a resistive load bank or a group of resistive load banks that are individually or groupwise selectively coupled to and decoupled from the grid.

The energy bank 40 provides a very fast absorbing capacity of excess electrical power, in an embodiment the energy bank 40 comprising a number of resistors 41, preferably air cooled or water cooled or a combination thereof. The resistors 41 are arranged to directly absorb electrical energy from the grid and convert it into heat. In an embodiment, the energy bank 40 comprises electrolysis units (not shown) instead of or in addition to resistors 41 for energy bank 40.

In an embodiment, the controller 50 is configured to determine or measure reactive power drawn from the controllable inverter 20, reduce reactive power drawn from the at least one controllable inverter 20, and cover reactive power with the one or more SD/ND alternators 34 when reactive power is above a reactive power threshold.

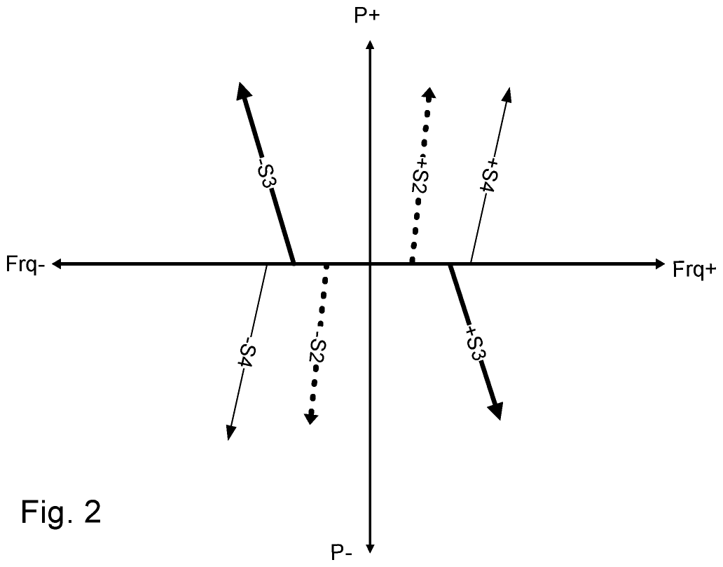

FIG. 2 illustrates a first control principle that is implemented by the controller 50. The controller 50 is configured to operate the at least one fluctuating source of power 14 as a slave to the grid, to measure grid frequency, to support grid frequency with the controllable inverter 20 to obtain a desired grid frequency, to supply power “+S3” from the electric battery 21 through the controllable inverter 20 to the grid when the measured grid frequency is below the desired grid frequency by more than a first lower margin, and to withdraw power “−S3” through the controllable inverter 20 from the grid to the electric battery 21 when the measured grid frequency is above the desired grid frequency by more than a second upper margin. The lower margin is at the root of the arrow +S3 and the upper margin is at the root of the arrow −S3. The controllable inverter 20 allows the grid frequency to vary within the first lower margin and the first upper margin.

The main control principle is controlling via frequency. This results in a high-power quality typically within approximately +/−0.4−0.8 Hz.

The grid frequency is measured with a high number of impulses per secs giving a fast reading of the frequency trend variations, hence allowing for fast adjustments.

The amount of power supplied to the grid by the battery 21 is increased according to a defined slope in kW/sec illustrated by the orientation of arrow “+S3”, substantially proportionally, with increasing deviation of the measured grid frequency below the first lower margin and vice versa. The amount of power withdrawn from the synchronous electrical grid 5 by the battery 21 is increased according to a defined slope in kW/sec illustrated by the orientation of the arrow “−S3”, proportionally with increasing deviation of the measured grid frequency above the first upper margin and vice versa.

Power is in an embodiment withdrawn under control from the controller 50 from the synchronous electrical grid 5 by the energy bank 40 when the measured grid frequency is below the desired grid frequency by more than a second lower margin, the second lower margin being smaller than the first lower margin, and power withdrawn from the synchronous electrical grid 5 under control of the controller 50 by the energy bank 40 is increased when the measured grid frequency is above the desired grid frequency by more than a second upper margin, the second upper margin being smaller than the first upper margin, Thus, the energy bank allows grid frequency to vary within the second lower and the second upper margin.

The amount of power withdrawn from the synchronous electrical grid 5 by the energy bank 40 is in an embodiment increased according to a defined slope in kW/sec illustrated by the orientation of the arrow “+S2”, proportionally, with increasing deviation of the grid frequency above the second upper threshold and vice versa. The amount of power withdrawn by the grid from the energy bank 40 is decreased according to a defined slope in kW/sec illustrated by the arrow “−S2”, proportionally, with increasing deviation of the grid frequency below the second lower threshold and vice versa.

Reactive power, inertia, and/or short-circuit effect in the synchronous electrical grid 5 are in an embodiment controlled by the controller 50 selectively coupling and decoupling the at least one or more SD/ND alternators 34 to the synchronous electrical grid 5 in parallel with the controllable inverter 20. The ND/SD alternators 34 act as electrical condensers.

Reactive power drawn from the controllable inverter 20 is in an embodiment measured, and at least one SD/ND 34 is coupled by the controller 50 to the grid in parallel with the controllable inverter 21 when reactive power drawn from the controllable inverter 21 exceeds a first reactive power threshold, preferably coupling one or more additional driven or non-driven alternators 34 to the grid in parallel with the controllable inverter 20 when reactive power drawn from the controllable inverter 20 remains above the first reactive power threshold.

One or more additional driven or non-driven alternators 34 are in an embodiment coupled to the synchronous electrical grid 5 by the controller 50 in parallel with the controllable inverter 20 when wind turbines 14 or other electric drives coupled to the synchronous electrical grid 5 are started up, preferably upon detection or notification of wind turbines fluctuating source of renewable energy 14 or other electric drives starting up.

According to an embodiment the controller 50 receives measurements of active power and reactive power, and the controller 50 is configured to minimize active power drawn from the controllable inverter 20 and covering reactive power with the at least one SD/ND alternator 34 when reactive power is above a reactive power threshold.

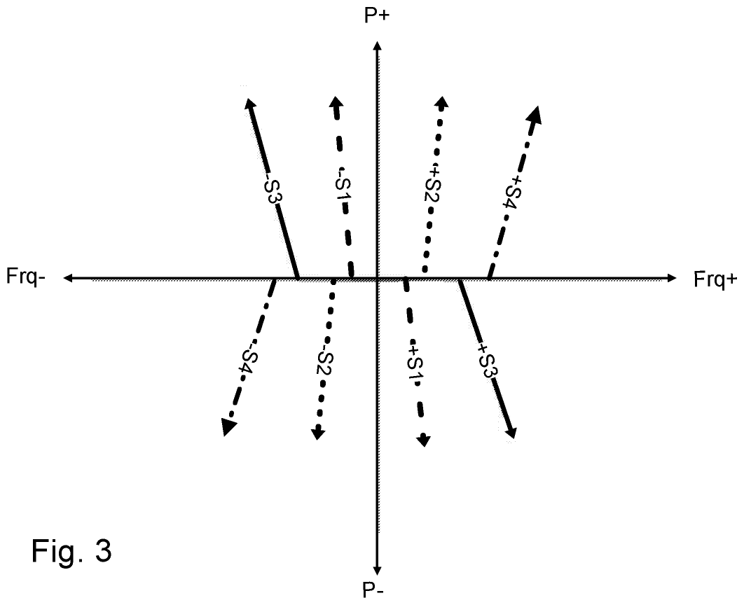

According to the second control principle illustrated in FIG. 3, which is combined with the first control principle, the controller 50 is configured to start increasing power production through one or more internal combustion engine driven alternators 34 according to a defined slope in kW/sec shown by the orientation of the arrow “−S1” when the measured grid frequency is below the desired grid frequency by more than a third lower margin, the third lower margin being smaller than the second lower margin. The root of the arrow “−S1” corresponds to the third lower margin. The faster controller 50 is configured to start reducing power production through one or more internal combustion engine driven alternators 34 when the measured grid frequency exceeds the desired grid frequency by more than a third upper margin according to a defined slope in kW/sec shown by the orientation of the arrow “+S1”. The third upper margin is smaller than the second upper margin and corresponds to the root of the arrow “+S1”. The controller 50 allows the operation of the internal combustion engine driven alternators 34 and effected the grid frequency varies within the third lower and the third upper margin.

In an embodiment, the controller 50 is configured to control the battery charge level of the battery 21 within a nominated control band, by increasing power withdrawn from the grid by the energy bank 40 when the battery charge level reaches the upper limit of the control band and/or for a grid having the alternator 34 driven by an internal combustion engine coupled thereto, starting and/or increasing engine power when the battery charge level reaches a lower limit of the control band.

In an embodiment, the controller 50 is configured to charge the battery 21 by withdrawing energy from the grid when surplus power is available from the fluctuating source of power 12,14.

In an embodiment control principle 1, is active in parallel with control principle 2.

The energy balancing function is in an embodiment based on the grid-forming battery inverter 20 operating in frequency control mode in parallel with controlling the alternators 34. In an embodiment where the alternators are coupled to an internal combustion engine 32 via clutch 36, the internal combustion engine 32 is clutched out and stopped when 100% or more renewable energy is available for the grid. In this scenario, the alternator 34 continues online drawn by the renewable energy or the energy from the battery 21. In an embodiment, energy bank control is used to assist to dampen fast and/or large energy fluctuations. In an embodiment, the energy bank 40 is frequency controlled. The controller 50 is configured to charge the battery 21 with surplus renewable energy and not from energy from an internal combustion engine 32.

When there is more than hundred percent renewable energy available to the grid, the controller 50 is configured to operate according to dynamic control principle 1. 100% and more renewable energy surplus is a situation where there is more renewable energy available than consumption on the consumer side. In this scenario, the controller 50 is configured to clutch out and stop the internal combustion engines 32 while the alternators 34 continue online rotating in parallel with the controllable battery inverter 20. The controller 50 is configured to increase and decrease the amount of power consumed by the energy bank 40 to assist dampen energy fluctuations caused e.g. by the fluctuating sources of renewable energy 14 and/or fluctuations in consumer demand.

In this scenario, the controllable inverter 20 operates in frequency control mode and controls the frequency within a deadband between the +S3 Hz to −S3 Hz frequency setpoints.

The renewable energy sources 14 are controlled by the controller 50 in response to battery charge level of the battery 21 within a nominated kW band in battery +S4 kWh to −S4 kWh. The controller 50 is in an embodiment configured to activate the energy bank 40 within deadband +S2 Hz to −S2 Hz frequency setpoints depending on the need for damping energy fluctuations. The deadband +S2 Hz to −S2 of the energy bank 40 can, as shown, be chosen to be within the deadband +S3 to −S3 of the controllable inverter 20, for reducing wear and tear on the battery 21 and also to dampen large power variations on the grid.

However, the deadband +S2 Hz to −S2 of the energy bank 40 can be chosen or adjusted to be outside the deadband +S3 to −S3 of the controllable inverter 20, in particular, to assist to dampen large power variations on the grid.

When less than 100% renewable energy is available the controller 50 is configured to operate according to this second control principle. Less than 100% renewable energy is the situation where the grid demand is larger than the power available either directly from wind and or PV and/or from stored in the battery 21. Internal combustion engines 32 are in operation and coupled to the alternators 34 operating with controlling the voltage and frequency of the grid in parallel with the controllable inverter 21. The controller 50 is configured to control the generator sets genset 30 within the deadband +S1 Hz to −S1 Hz frequency setpoints, to control the controllable inverter 20 within the deadband +S3 Hz to −S3 Hz setpoints, and to optionally control the activation of the energy bank 40 within the deadband +S2 Hz to −S2 Hz frequency setpoints, depending also on the need for damping energy fluctuations.

When the grid frequency increases, e.g. due to increasing renewable energy and or decreasing consumption the controller 50 is configured to:
decrease energy production from the combustion engine driven alternators 34 gensets 30 at +S1 Hz,
increase our consumption by the energy bank 40 at +S2 Hz, and
to increase battery charge at +S3 Hz.

If the last genset 30 cannot operate down to zero load, the controller 50 will load energy bank 40 with a load similar to the least genset minimum load, where after the internal combustion engine 34 is clutched out and stopped preferably after a length of time delay in which the grid has been stable for a nominated period. Alternatively, the controller 50 may charge increased charging of the battery 21. Battery charging may be increased until this charging level is similar to minimum load on the genset 30 before internal combustion engine 32 is clutched out and stopped, preferably after a length of time delay in which the grid has been stable for a nominated period.

The active energy bank controlling 40 is optional. Activation of the energy bank 40 depends on fluctuations or risk of periods with large fluctuations or depending on the condition of the battery 21. In a scenario where the grid frequency decreases, e.g. due to decreasing renewable energy and or increasing consumption the controller 50 is configured to:
increase production using the internal combustion engine 34 at −S1 Hz, and
to increase production from the battery 21 at −S3 Hz.

In an embodiment in which there is no energy bank 40 or the energy bank 40 is non-active, its functionality above is eliminated in the main control method and system function without energy bank 40.

If the energy bank 40 is loaded it can increase and decrease load. If non-loaded, the energy bank 41 can only increase load. In an embodiment, a continuous load on energy bank 40 is used for heating purposes.

The additional storage solution is in an embodiment integrated into the above control logic and instead of reducing PV and wind, the surplus energy is the capturing into the storage solution. Additional storage may feed storage energy back into the system via the nominated grid-forming battery inverter system or by its own electrical energy generation system depending on the type of technology.

A battery 21 charge level band is nominated, where battery charge level is kept for having both capacity available for energy production to cover load 100% and energy charging to absorb surplus energy 100% to balance the load variations. The controller 50 uses the charge level band in the battery 21 for control of the renewable energy production by continuously providing a maximum power reference. The charge level band is defined based on a kW-charge level band operation area in the battery 21 where there is the least wear and tear on the battery. The renewable energy sources 14. e.g. wind, solar are slaves and operate within and up to a controlled maximum power output limit.

In an embodiment the controller 50 is configured to: operate the at least one fluctuating source of power 14 as a slave to the synchronous electrical grid 5 up to a controlled maximum power output limit, to measure grid frequency, to support grid frequency with the controllable inverter 20 to obtain a desired grid frequency, to monitor the charge level of the battery 21, and to reduce the controlled maximum power output limit when the charge level of the battery 21 exceeds an upper battery charge level threshold.

In an embodiment where the fluctuating source of power comprises a solar panel and a wind turbine, the controller 50 comprising reducing power from the solar panel before reducing power from the wind turbine when reducing the maximum power level and vice versa. In an embodiment, the controller 50 is configured to increase power absorbed by the energy bank 40 when the battery charge level exceeds the battery charge level threshold.

In an embodiment, the controller 50 is configured to activate a motor and/or engine driven alternator 34 coupled to the grid by starting the motor or engine by coupling a running motor or engine to the alternator 34 when the battery charge level is below a lower battery charge level threshold.

In an embodiment the controller 50 is configured to operate the at least one fluctuating source of power 14 as a slave to the grid up to a controlled maximum power output limit, to measure grid frequency, to support grid frequency with the controllable inverter 20 as to obtain the desired grid frequency, to monitor the temperature of the battery 21, and to absorbing surplus power with the battery 21 when the battery temperature is below a first battery temperature threshold, to absorb surplus power with the energy bank 40 when the battery temperature is above a first battery temperature threshold and/or absorb surplus power with the energy bank 40 when an increase in surplus power accelerates above a level defined by a first surplus power acceleration threshold. The controller 50 can in this embodiment further be configured to reduce power from the at least one fluctuating source of power 14 when the battery temperature is above the first threshold and/or when the energy bank 40 is absorbing energy at a level above a first energy bank absorption capacity level.

When alternators 34 are online the reactive power are probably covered by the online alternators 34. Voltage is covered by the controllable inverter 20 and/or the online alternators 34. When the reactive power from the alternators 34 approaches 0 kVar, fluctuating source of renewable energy 14 inverters will be ordered to absorb a small amount of reactive power.

The number of SD/ND alternators 34 of the total alternator fleet remaining online is in an embodiment determined by, but not limited to, below requirements that are constantly calculated:
1. Reactive power requirements
2. Short circuit effect requirements
3. System electrical stability requirements incl. stability in inverter systems

For system electrical stability, the controller 50 makes active use of the mechanical inertia kinetic energy and electrical cadence of the online alternator fleet. If no genset 30 with clutch 36 is available, then non-driven alternators 34 operating as separate condenser system can take over the role of disengaged online alternator capacity with a similar operation strategy. Additional condenser capacity is added if there is too little available alternator capacity in the system.

At a first nominated setpoint for reactive power in the total energy system, the controller 50 commands the fluctuating source of renewable energy 14 to assist in reactive power production. Preferably, the wind turbines are started before the photovoltaic units.

At a second nominated setpoint for reactive power in the total energy system, the controller 50 commands the controllable inverter 21 to assist in reactive power production.

The controller 50 is configured to monitor temperatures and cell voltage of the battery 21.

If battery 21 reaches temperature max setpoint power from the photovoltaic sources 14 is reduced before reducing power from the wind turbines 14 until a minimum charge level in the nominated control band of the battery 21 is reached.

When the battery reaches a high temperature threshold, the controller 50 controls the energy bank 40 within deadband +S2 Hz to −S2 Hz. The controller 50 also activates the energy bank 40 to dampen energy fluctuations in battery 21.

To protect the battery 21 controller 50 applies the following strategies:
1. The controllable inverter 20 is set to allow increase in frequency at large power increases. For this strategy, the energy bank 40 will have an activation set point after +S3 Hz and will here start to assist to dampen the large power increase.
2. The energy bank 40 increases load based on charge level in battery 21 increasing above upper charge level setpoint in control band in battery +S4 kWh at the same time as power from the wind turbines 14 wind and/or solar panels 12 is reduced.
3. The energy bank 40 is commanded to put in load as per ramp based on increase in power into battery 21 when a fast increase in power to the battery 21 or an increase in frequency is identified.

In an embodiment, the controller 50 is configured to operate the one or more selectively driven alternators 34, with a fixed load or power saving when they are driven by the internal combustion engine 32. The selectively driven alternator 34 preferably being operated with a fixed load or power setting for a predetermined length of time, with the fixed load or power setting changing periodically.

In FIG. 1 a hydrogen generating unit electrolysis unit 64 is powered by electric power from the fluctuating renewable energy source 14, and another electrolysis unit 64 is powered by power from the busbar 10. However, it is understood that is not required that the system has more than one electrolysis unit 64. The electrolysis unit 64 has an inlet for water and hydrogen outlet and an oxygen outlet. As illustrated in FIG. 5, the hydrogen outlet of the electrolyzers unit 64 is connected to a hydrogen inlet of a hydrogen storage tank 136 by a feed conduit that includes a compressor unit 140 driven by an electric motor 66. The hydrogen is either stored at high pressure in the hydrogen storage tank 136, or the hydrogen is liquefied stored in liquid form in the hydrogen storage tank 136. The hydrogen storage tank 136 is part of the hydrogen fuel system 70. The hydrogen fuel system 70 comprises a hydrogen supply line that connects a hydrogen outlet of the hydrogen storage tank 136 to the internal combustion engine 132, preferably to the hydrogen fuel valves of the internal combustion engine 132.

A high pressure hydrogen pump 134 driven by an electric motor 138 raises the pressure of the hydrogen in the hydrogen supply line to the required injection pressure. In an embodiment, the fuel valves of the engine may include a pressure booster for further increase of the pressure of the hydrogen fuel for injection into the engine. In an embodiment, the engine 32 is a compression-ignition engine, in which the hydrogen is injected at or near the top dead center of the pistons. In another moment the engine is a spark-ignition engine, in which the fuel is mixed with the charging air the air-fuel mixture is compressed and ignited by a spark for other ignition means at or near top dead center TDC of the pistons. If the hydrogen is stored in liquid form in the storage tank 136, the hydrogen supply line will include a vaporizer 135 for vaporizing the hydrogen before supplied to the internal combustion engine/fuel valves of the internal combustion engine. In an embodiment, the internal combustion engine 32 is a dual fuel engine, that is configured in one mode to operate on hydrogen and in another mode to operate on a conventional fuel, e.g. fuel oil.

The cells of the electrolysis unit 64 comprise in the present embodiment polymer electrolyte membrane cells PEM or alkaline electrolysis cells AECs. Alkaline electrolysers generally use nickel catalysts and are inexpensive but not very efficient. PEM electrolysers, generally use platinum group metal catalysts are more efficient and can operate at higher current densities. PEM electrolysis cells typically operate below 100 °C and are comparatively simple and accept widely varying voltage inputs which renders them suitable for use with renewable sources of energy such as solar PV or wind turbines. AECs operate optimally at high concentrations electrolyte KOH or potassium carbonate and at high temperatures, typically near 200 °C.

The fuel cell 85 comprises an electrochemical cell that converts the chemical energy of the hydrogen with an oxidizing agent, preferably oxygen from air, into electricity through a pair of redox reactions. The fuel cell 85 is coupled to the hydrogen fuel system 70. A hydrogen supply line connects a hydrogen inlet of the fuel cell 85 to the outlet of the hydrogen storage tank 136. In an embodiment, the engine supply line includes a vaporizer 84 and a control valve 82 that controls the flow of hydrogen from the hydrogen storage tank 136 to the fuel cell 85. The control valve 82 is coupled to the controller 50.

The one or more selectively driven alternators 34, are selectively operably couplable by a clutch 36 to the internal combustion engine 32 operated on hydrogen or a mixture of hydrogen and another fuel. The clutch 36 is controlled by the controller 50. When the role of the one or more selectively driven alternators 34 needs to be changed from a role of creating inertia to a role of also maintaining the network frequency, the controller 50 will start up the internal combustion engine 32 and thereafter engage the clutch 36 so that the already rotating alternator 34 is coupled to and driven by the internal combustion engine 32. Thus, the controller 50 is configured to clutch-in the internal combustion engine 32 when the internal combustion engine 32 is at synchronous rpm with the selectively driven alternator 34.

The internal combustion engine 32 is equipped for pre-pressuring and heating for optimal operation in lower loads and for having fast response and startup with one or more of below technical solutions—but not limited to—as follows:

For pre-pressuring the engine, the selectively driven alternator 34 is equipped with an air duct system for ventilation air for connecting to nominated engine filter housing as m described in EP0745186 or alternatively, the internal combustion engine 32 is equipped with a separate pre-pressuring system for similar pressure effect to nominated engine filter housing.

For control of heating of the internal combustion engine 32 the air cooler system is separated from the engine and controlled by temperature as per system described in EP0745186.

For control of heating of the internal combustion engine 32 the internal combustion engine 32 is equipped with a pre-heating system described in EP0745186.

The controller 50 is configured to powering the at least one hydrogen generating unit 64 with power from the at least one fluctuating source of electric power 14 when, and preferably only when, actual electric power generated by the at least one fluctuating source of electric power 14 exceeds actual consumer power demand and battery charge level have reached an upper charge level set point and simultaneously hydrogen storage capacity is available in the hydrogen storage unit 136, so that hydrogen and oxygen is generated with the at least one hydrogen generating unit 64. The hydrogen generated by the at least one hydrogen generating unit 64 is stored in the hydrogen storage unit, e.g. hydrogen storage tank 136.

The controller 50 is also configured to generate power with the at least one selectively driven alternator 34 by combusting hydrogen from the hydrogen storage unit 136 or a mixture of hydrogen from the hydrogen storage unit 136 and another fuel in the internal combustion engine 32, when actual electric power generated by the at least one fluctuating source of electric power 14 is less than the actual consumer power demand and battery charge level has reached a lower charge level set point and simultaneously the amount of hydrogen in the hydrogen storage unit 136 is above a hydrogen amount threshold. The hydrogen amount threshold is greater than or equal to 0.

The controller 50 is configured to generate power with the at least one selectively driven alternator 34 by combusting hydrogen from the hydrogen storage unit 136 or a mixture of hydrogen from the hydrogen storage unit 136 and another fuel in the internal combustion engine 32, when the charge level of the electric battery 21 is below a first battery charge level threshold.

The controller 50 is configured to ramp up and down hydrogen production with the electrolysis system 64 as a function, preferably a proportional correlation, of the availability of actual surplus electric power generated by the at least one fluctuating source of electric power 14. The actual surplus electric power is defined as the amount to which the actual power generated by the at least one fluctuating source of electric power 14 exceeds the actual consumer power demand. The controller 50 is in an embodiment configured to ramp up and down hydrogen production with the hydrogen generating unit 64 as a function, preferably a proportional correlation, of the frequency of the grid. Both methods of ramping up and down the activity of the hydrogen production unit 64 can be combined.

In an embodiment, hydrogen generated by the hydrogen generating unit 64 is pressurized using a high-pressure pump 140 driven by an electric drive motor 66. In an embodiment, the hydrogen is also liquefied in the process. The controller 50 is configured to powering the electric drive motor 138 with electric power generated by at least one fluctuating source of electric power 14.

In an embodiment, the internal combustion engine 32 operates on a mixture hydrogen from the hydrogen storage unit 136 and another fuel such as fuel oil pilot oil. The fuel oil can be supplied to the internal combustion engine separately from the hydrogen. The fuel oil can be supplied as a pilot oil, i.e. as an oil that ensures ignition. Preferably the fuel oil is injected at high pressure from fuel valves and the injection of the fuel oil can be timed for timed ignition.

In an embodiment, the internal combustion engine 32 is a compression ignited engine, i.e. an engine operating to the Diesel principle, and fuel is injected when the pistons are at or near top dead center.

In an embodiment, the internal combustion engine 32 operates according to the Otto principle, and a mixture of fuel and charging air is compressed during the stroke of the pistons from bottom dead center to top dead center.

In an embodiment, the mixture of hydrogen from the hydrogen storage unit and another fuel comprises a mixture of hydrogen from the hydrogen storage unit and one or more of petroleum gas, natural gas, syngas, biogas, ammonia. Biogas can be a mixture of gases, primarily consisting of methane, carbon dioxide, and hydrogen sulphide, produced from raw materials such as agricultural waste, manure, municipal waste, plant material, sewage, green waste, and food waste.

The controller is configured to determine the actual consumer AC power demand the actual electric power generated at least one fluctuating source of electric power 14 and the actual consumer power demand with the actual electric power generated by at least one fluctuating source of electric power 12,14.

The controller 50 is configured to generate power with the at least one selectively driven alternator 34 by combusting fuel other than hydrogen from the hydrogen storage unit 136, e.g. fuel from a fuel oil tank 90, in the internal combustion engine 32, when simultaneously the amount of hydrogen in the hydrogen storage unit 136 is below a hydrogen amount threshold and simultaneously battery charge level has reached a lower charge level set point, and preferably actual electric power generated by the at least one fluctuating source of electric power 14 is less than the consumer power demand.

The controller 50 is configured to generate power with the at fuel cell 85 by converting hydrogen from the hydrogen storage unit 136 into DC power and converting the DC power into AC power with the inverter when the actual electric power generated by the at least one fluctuating source of electric power 14 is less than the consumer power demand and simultaneously the amount of hydrogen in the hydrogen storage unit 136 is above a hydrogen amount threshold, the hydrogen amount threshold being greater than or equal to 0.

In an embodiment, the controller 50 is configured to support grid frequency with the controllable inverter 20 to obtain a desired grid frequency, supply power from an electric battery 21 through the controllable inverter 20 to the grid when the measured grid frequency is below the desired grid frequency by more than a first lower margin, and withdraw power through the controllable inverter 20 from the grid to the electric battery 20 when the measured grid frequency is above the desired grid frequency by more than a second first upper margin.

In an embodiment, the controller 50 is configured to increase AC power production with the fuel cell 85 and the inverter 20 according to a defined slope when the measured grid frequency is below the desired grid frequency by more than a fourth lower margin, decreasing power production with the fuel cell 85 and the inverter 20 according to a defined slope when the measured grid frequency exceeds the desired grid frequency by more than a fourth upper margin.

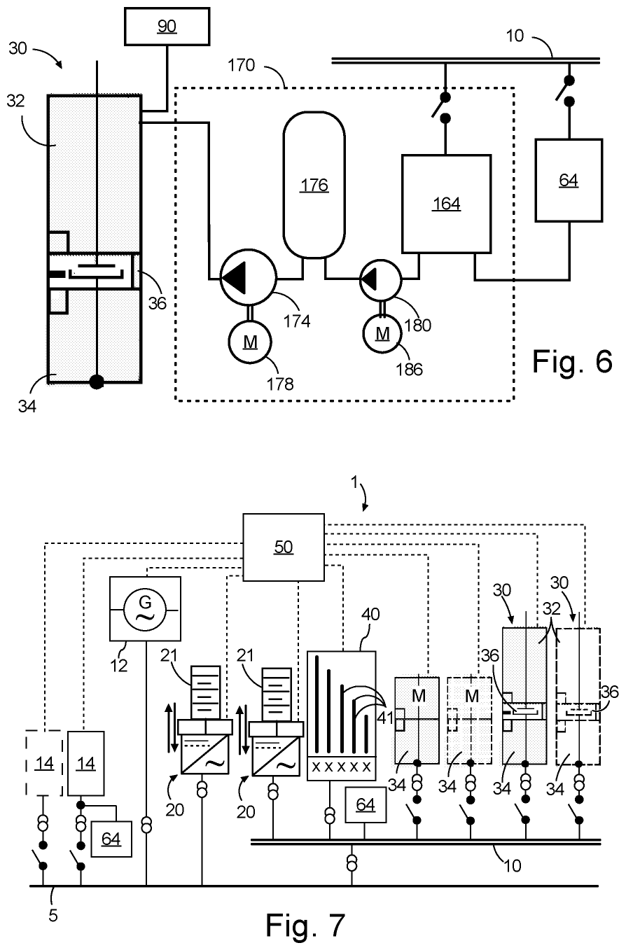

FIG. 6 shows another embodiment of the system. In this embodiment, structures and features that are the same or similar to corresponding structures and features previously described or shown herein are denoted by the same reference numeral as previously used for simplicity. In this embodiment, the system comprises a two-stage power to gas system 170, in which the hydrogen that is generated in the hydrolysis unit 64 is converted into fuel gas, e.g. syngas, methane, or liquid petroleum gas LPG by a hydrogen to fuel gas conversion unit 164. The hydrogen to fuel gas conversion unit 164 is powered e.g. by a connection with the busbar 10. The fuel gas that is generated by the fuel conversion unit 164 is stored in a fuel gas storage unit 176. In this embodiment, the controller 50 is configured in a similar fashion to the embodiment above, to use only electrical power for generating fuel gas when there is a surplus of power from the fluctuating sources of renewable energy. The fuel gas stored in the fuel gas storage unit 176 is supplied to the internal combustion engine via a fuel pump 174 that is driven by an electric motor 178, and that is under control of the controller 50. The operation and control of the two-stage power to gas system 170, is essentially identical to the operation of the hydrogen fuel system 70.

FIG. 7 shows another embodiment of the system. In this embodiment, structures, and features that are the same or similar to corresponding structures and features previously described or shown herein are denoted by the same reference numeral as previously used for simplicity. In this embodiment is similar to the embodiment of FIG. 1 with the main difference being that there are two controllable inverters 20 coupled to the synchronous electrical grid. The synchronous electrical grid 5 is required to have a stable desired grid voltage and frequency. The system comprises at least one fluctuating source of power 14 generated from renewable energy coupled to the synchronous electrical grid 5, preferably coupled to the synchronous electrical grid 5 by an inverter.

The consumers creating a fluctuating power demand on the synchronous electrical grid 5. There are one or more, e.g. two controllable inverters 20, the two controllable inverters 20 are coupled to an electric battery 21 and to the synchronous electrical grid 5. The one or more controllable inverters 20 are configured to be switchable between a grid-forming mode and a grid supporting mode. The at the two controllable inverters 20 establish the desired grid frequency and voltage in the grid-forming mode, and the one or more controllable inverters 20 support the desired grid frequency and voltage in the supporting mode. The system comprises a controller 50 configured to:
operate the one or more controllable inverters 20 per default in grid supporting mode,
detect whether there is enough grid-forming capacity coupled to the synchronous electrical grid 5 for ensuring stable desired grid voltage and frequency,
switch at least one of the one or more controllable inverters 20 to grid-forming mode when there is not enough grid-forming capacity coupled to the synchronous electrical grid 5 for ensuring the stable desired grid voltage and frequency.

Accordingly, the synchronous electrical grid is support by the controllable inverters 20 when there is insufficient for forming capacity coupled to the synchronous electrical grid 5, i.e. there is a risk of grid instability. By having one or more controllable inverters 20 that each are switchable between grid-forming and supporting mode, and by switching each controllable inverter 20 between grid-forming and grid supporting mode, the stability of the synchronous electrical grid can be supported in a way that maximizes the support capacity of the frailty of controllable inverters 20

According to a possible implementation of the eighth aspect, the least the one or more controllable inverter 20 is connected to the synchronous electrical grid 5 in parallel, in the present embodiment by connecting one of the one or more controllable inverters 20 to the busbar 10 and the other of the controllable inverter 22 Directly to the synchronous grid 5. Each of the one or more controllable inverters 20 is preferably connected to an individual battery 21, but it is also possible that the one or more controllable inverters 20 share a single battery 21.

The system is provided with sensors or other means to measure grid frequency and determine that there is not enough grid-forming capacity coupled to the synchronous electrical grid 5 when the measured grid frequency deviates more from the desired grid frequency by more than a predetermined frequency deviation threshold.

The one or more controllable inverters 20 are configured regulating their output voltage and frequency in the grid-forming mode and the one or more controllable inverters 20 are configured to support the synchronous electrical grid 5 by supplying active and reactive power in the grid supporting mode.

FIG. 8 shows another embodiment of the system. In this embodiment, structures, and features that are the same or similar to corresponding structures and features previously described or shown herein are denoted by the same reference numeral as previously used for simplicity. This embodiment is similar to the embodiment of FIG. 7 with the only difference that both of the one or more controllable inverters 20 are connected to the busbar 10.

The embodiment of FIGS. 1,7 and 8 can be provided with an electrolysis unit (not shown). This electrolysis unit, or the electrolysis unit 64 of the embodiment of FIGS. 5 and 6, is used as a controllable load bank. Thus, there is created a system a system for supporting an AC electrical grid 5 comprising:
at least one fluctuating source of AC electric power 12,14 generated from renewable energy coupled to the AC electrical grid for supplying AC electric power to the AC electrical grid,
consumers coupled to the AC electrical grid creating a fluctuating consumer AC electric power demand on the AC electrical grid,
an electrolysis unit of a hydrogen generating unit 64 coupled to the AC electrical grid, the electrolysis unit having a capacity to withdraw a variable amount of power from the AC electrical grid 5, and
   a controller 50 configured for controlling grid frequency with the grid-forming controllable inverter 20 as master controller to obtain a desired grid frequency.

The controller is informed of grid frequency and voltage of the AC electrical grid and the controller 50 is configured to:
supply power from the electric battery 21 through the grid-forming controllable inverter 20 to the grid when the measured grid frequency is below the desired grid frequency by more than a first lower margin,
withdraw power through the grid-forming controllable inverter 20 from the grid to the electric battery 21 when the measured grid frequency is above the desired grid frequency by more than a first upper margin, and
reduce power withdrawn from the grid by the electrolysis unit when the measured grid frequency is below the desired grid frequency by more than a fifth lower margin, and
increase power withdrawn from the grid by the electrolysis unit when the measured grid frequency is above the desired grid frequency by more than a fifth upper margin, preferably comprising the electrolysis unit allowing grid frequency to vary within the fifth lower and the fifth upper margin.

Accordingly, by replacing the controllable load bank 40 with an electrolysis unit, surplus power on the grid can be used to generate hydrogen instead of heat.

The values for the fifth lower margin and the fifth upper margin are in a variation of this embodiment equal to the values for the deadband +S2 to −S2 of the energy bank 40 in the embodiments above. If there an energy bank 40 is simultaneously used with the electrolysis unit, this energy bank 40 will preferably operate with a dead band with a slightly lower threshold and a slightly higher higher threshold than the lower and higher thresholds of the electrolysis unit, respectively.

The controller 50 is configured to increase the amount of power withdrawn from the AC electrical grid by the electrolysis unit 64 according to a defined slope, preferably proportionally, with increasing deviation of the grid frequency above the second upper threshold and vice versa, and decrease the amount of power withdrawn from the AC electrical grid by the electrolysis unit 64 according to a defined slope, preferably proportionally, with increasing deviation of the grid frequency below the second lower threshold.

The AC electrical grid may still have coupled thereto the controllable resistive load-bank 40, the resistive load-bank having a capacity to withdraw a variable amount of power from the AC electrical grid 5, the controller 50 being configured to:
reduce power withdrawn from the AC electrical grid by the resistive load-bank 40 when the measured grid frequency is below the desired grid frequency by more than a second lower margin, the second lower margin being larger than the fifth lower margin, and increase power withdrawn from the AC electrical grid by the resistive load-bank 40 when the measured grid frequency is above the desired grid frequency by a second upper margin, the second upper margin being smaller than the fifth upper margin, preferably comprising the resistive load-bank 40 allowing grid frequency to vary within the second lower and the second upper margin.

In an embodiment (not shown), the system comprises a two-stage power to liquid fuel system, in which hydrogen that is generated in the hydrolysis unit 64 is converted into a liquid fuel, e.g. methanol by a hydrogen to liquid fuel conversion unit. The operation and control of the two-stage power to gas system, is essentially identical to the operation of the hydrogen fuel system 70.

In an embodiment, the system uses a single-stage power to gas system to produce methane using such as reversible solid oxide cell ReSOC technology. In this embodiment, methane produced using surplus energy from the fluctuating sources of renewable energy 14 is stored in a methane tank and supplied by the fuel supply system to the internal combustion engines 32 when needed. The operation and control of the one-stage power to gas system, is essentially identical to the operation of the hydrogen fuel system 70.

In an embodiment, the controllable inverter is controlled to cover active power, not reactive power, and reactive power coupling in one or more of the one or more selectively driven or non-driven alternators.

In an embodiment, the controllable inverter 20 is controlled to cover active power, not reactive power, and reactive power coupling in one or more of the one or more SD/ND alternators 34.

The functions of the controller 50 can be distributed over several control units, the control units being in communication with one another. One such control unit can e.g. be part of the controllable inverter 20 or of the genset 30 or any other device that is part of the energy supply system 1.

In an embodiment, the controllable inverter 20 is controlled to cover active power, not reactive power, and reactive power is covered by coupling in one or more of the one or more selectively driven or non-driven alternators 34 to the synchronous electrical grid 5.

In an embodiment, the deadband +S2 Hz to −S2 of the energy bank 40 can be chosen according to operating conditions to be within the deadband +S3 to −S3 of the controllable inverter 20, for reducing wear and tear on the battery 21 and also to dampen large power variations on the synchronous electrical grid 5.

In an embodiment, the deadband +S2 Hz to −S2 of the energy bank 40 can be chosen or adjusted according to operating conditions to be outside the deadband +S3 to −S3 of the controllable inverter 20, in particular, to assist to dampen large power variations on the grid 5.

In an embodiment, the deadband of the energy bank can be chosen according to operating conditions to start within the deadband +S3 to −S3 of the controllable inverter 20, for reducing wear and tear on the battery 21 from small power variations and then at larger power variations to be outside the deadband +S3 to −S3 of the controllable inverter 21 to benefit from both of above strategies.

In an embodiment, the controller is configured to operate the energy bank to put in load steps when the kW charge level into the battery exceeds the charge level limit for the battery. Preferably this possible implementation form takes into account that the limit of the charge level into the battery is a function of the charge level of the battery.

In an embodiment, the controller is configured to put in load steps for the energy bank when power from the at least one fluctuating source of power generated from renewable energy is reduced as a consequence of the charge level limit for the battery.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single controller or other unit may fulfill the functions of several items recited in the claims. The mere fact that certain measures are recited in mutually different dependent claims does not indicate that a combination of these measured cannot be used to advantage. The reference signs used in the claims shall not be construed as limiting the scope. Unless otherwise indicated, the drawings are intended to be read e.g., cross-hatching, arrangement of parts, proportion, degree, etc. together with the specification, and are to be considered a portion of the entire written description of this disclosure.

1. A method of supporting a synchronous electrical grid, the synchronous grid having coupled thereto:
at least one fluctuating source of power generated from renewable energy, preferably coupled to the synchronous electrical grid by an inverter,
one or more grid-forming alternators powered by a steady source of energy and operated with rotational inertia to provide phase based inertia active power,
consumers creating a fluctuating power demand,
at least one controllable inverter coupled to an electric battery, and
one or more selectively driven or non-driven alternators each having mechanical rotational inertia, the one or more selectively driven or non-driven alternators being selectively coupled to the synchronous electrical grid in parallel with the at least one controllable inverter, the method comprising supporting the synchronous electrical grid by:
operating the at least one controllable inverter with synthetic rotational inertia to provide inverter phase based inertia active power up to a first threshold,
coupling one or more of the selectively driven or non-driven alternators to the synchronous electrical grid for supplying additional phase based inertia active power, when inverter phase based inertia active power is equal or above a first power threshold, and
decoupling one or more of the selectively driven or non-driven alternators from the synchronous electrical grid when one or more of the selectively driven or non-driven alternators are coupled to the synchronous electrical grid and inverter phase based inertia active power is equal to or below a second power threshold, the second power threshold being equal to or lower than the first power threshold.

2. The method of claim 1, comprising:
measuring grid frequency, preferably at the terminals of the at least one controllable inverter,
coupling one or more of the selectively driven or non-driven alternators to the synchronous electrical grid when frequency anomaly of the measured grid frequency is above a first frequency anomaly threshold, and
preferably decoupling one or more of the selectively driven or non-driven alternators from the synchronous electrical grid when one or more of the selectively driven or non-driven alternators are coupled to the synchronous electrical grid and frequency anomaly of the measured grid frequency is or below a second frequency anomaly threshold, the second frequency anomaly being lower than the first frequency anomaly threshold.

3. The method of claim 1, comprising:
measuring grid voltage, preferably at the terminals of the at least one controllable inverter,
coupling one or more of the selectively driven or non-driven alternators to the synchronous electrical grid when voltage anomaly of the measured grid voltage is above a first voltage anomaly threshold, and
preferably decoupling one or more of the selectively driven or non-driven alternators from the synchronous electrical grid when one or more of the selectively driven or non-driven alternators are coupled to the synchronous electrical grid and voltage anomaly of the measured grid voltage is below a second voltage anomaly threshold, the second voltage anomaly threshold being equal to or lower than the first voltage anomaly.

4. The method of claim 1, comprising
determining short circuit ratio or level, preferably at the terminals of the controllable inverter,
coupling one or more of the selectively driven or non-driven alternators to the synchronous electrical grid when the determined short circuit or level is above a first short circuit ratio or level threshold, and
preferably decoupling one or more of the selectively driven or non-driven alternators from the synchronous electrical grid when one or more of the selectively driven or non-driven alternators are coupled to the synchronous electrical grid and the determined short circuit ratio or level is below a second short circuit ratio or level threshold, the second short circuit ratio or level threshold being equal to or lower than the first short circuit ratio threshold or level.

5. The method of claim 1, comprising
coupling one or more of the selectively driven or non-driven alternators to the synchronous electrical grid when reactive power supplied by the controllable inverter is above a first reactive power threshold, and
preferably decoupling one or more of the selectively driven or non-driven alternators from the synchronous electrical grid when one or more of the selectively driven or non-driven alternators are coupled to the synchronous electrical grid and the reactive power supplied by the controllable inverter is below a second reactive power threshold, the second reactive power threshold being equal to or lower than the first reactive power threshold.

6. The method of claim 1, wherein the controllable inverter is configured to support a desired grid frequency by:
supplying power from the electric battery through the at least one controllable inverter to the synchronous electrical grid when the measured grid frequency is below a desired grid frequency by more than a first lower margin, and
withdrawing power through the at least one controllable inverter from the synchronous electrical grid to the electric battery when the measured grid frequency is above the desired grid frequency by more than a first upper margin.

7. The method of claim 1, wherein the controllable inverter comprises one or more of: a grid following mode of operation, a grid supporting mode of operation, a grid-forming mode of operation, the method comprising operating the controllable inverter in the grid following mode of operation, the grid supporting mode of operation, or the grid-forming mode of operation, and preferably comprising switching to the grid-forming mode when there is not enough grid-forming capacity coupled to the synchronous electrical grid for ensuring said stable desired grid voltage and frequency or when one or more of the one or more selectively driven or non-driven alternators are coupled to the synchronous electrical grid.

8. (canceled)

9. The method of claim 1, comprising supporting the magnitude and angle of the grid voltage at the terminals of the controllable inverter (20) with the controllable inverter (20) operating in its grid-forming mode, or
comprising supporting the magnitude and angle of the grid voltage with the selectively driven or non-driven alternators coupled to the synchronous electrical grid.

10. (canceled)

11. The method of claim 1, comprising controlling the power injected by the controllable inverter, preferably comprising estimating the fundamental frequency phasor of the grid voltage, so as to generate the instantaneous value of the current reference and the voltage reference.

12. The method of claim 1, comprising bringing the one or more selectively driven or non-driven alternators up to synchronous speed using an electric motor M or an internal combustion engine before coupling the one or more selectively driven or non-driven driven alternators to the synchronous electrical grid, preferably shortly before coupling the one or more selectively driven or non-driven alternators to the synchronous electrical grid.

13. The method of claim 1, comprising increasing the amount of power supplied to the synchronous electrical grid by the battery through the controllable inverter according to a defined slope, preferably substantially proportionally, with increasing deviation of the measured grid frequency below a first lower margin and vice versa, and increasing the amount of power withdrawn from the grid by the battery according to a defined slope, preferably proportionally with increasing deviation of the measured grid frequency above the first upper margin.

14. The method according to claim 1, comprising a controllable resistive load-bank coupled to the synchronous electrical grid, the resistive load-bank having a capacity to withdraw a variable amount of power from the synchronous electrical grid, and the resistive load-bank preferably having a capacity to change the amount of energy withdrawn from the synchronous electrical grid faster than the battery can change the amount of power withdrawn from the synchronous electrical grid,
reducing power withdrawn from the synchronous electrical grid by the resistive load-bank when the measured grid frequency is below the desired grid frequency by more than a second lower margin, the second lower margin preferably being smaller than the first lower margin, and increasing power withdrawn from the synchronous electrical grid by the resistive load-bank when the measured grid frequency is above the desired grid frequency by more than a second upper margin, the second upper margin preferably being equal to or smaller than the first upper margin, preferably comprising the resistive load-bank allowing grid frequency to vary within the second lower and the second upper margin.

15. The method according to claim 14, comprising:
increasing the amount of power withdrawn from the synchronous electrical grid by the resistive load-bank according to a defined slope, preferably proportionally, with increasing deviation of the grid frequency above the second upper margin and vice versa, and decreasing the amount of power withdrawn from the synchronous electrical grid by the resistive load-bank according to a defined slope, preferably proportionally, with increasing deviation of the grid frequency below the second lower margin.

16. The method according to claim 1, comprising coupling one or more of the one or more selectively driven or non-driven alternators to the synchronous electric grid when one or more of:
frequency anomalies are above a frequency anomaly threshold,
voltage anomalies are above a voltage anomaly threshold,
power supplied by the at least one controllable inverter exceeds a power supply threshold,
power absorbed by the at least one controllable inverter exceeds a power absorption threshold,
when one or more of the one of more grid-forming alternators decouple from the synchronous electrical grid,
when power demand by the consumers increases with a speed above a speed increase threshold,
when power supply by the at least one fluctuating source of power decreases with a speed above a speed decrease threshold.

17. The method according to claim 1, comprising determining or measuring reactive power drawn from the controllable inverter, reducing reactive power drawn from the at least one controllable inverter, and covering reactive power with the one or more selectively driven or non-driven alternators when reactive power is above a reactive power threshold.

18. The method according to claim 1, wherein the at least one selectively driven alternator is selectively operably couplable to an internal combustion engine.

19-20. (canceled)

21. A method for supporting a synchronous electrical grid, the synchronous electrical grid having coupled thereto:
at least one fluctuating source of power generated from renewable energy,
one or more grid-forming alternators powered by a steady source of energy,
consumers creating a fluctuating power demand, and
at least one controllable inverter coupled to an electric battery, the method comprising:
establishing grid frequency and voltage with the one or more grid-forming alternators as master controller to obtain a desired grid frequency and voltage,
operating the at least one fluctuating source of power as a slave to the synchronous electrical grid,
measuring grid frequency of the synchronous electrical grid, preferably at the terminals of the controllable inverter,
supporting grid frequency by:
supplying power from the electric battery through the at least one controllable inverter to the synchronous electrical grid when the measured grid frequency is below the desired grid frequency by more than a first lower margin, and
withdrawing power through the at least one controllable inverter from the synchronous electrical grid to the electric battery when the measured grid frequency is above the desired grid frequency by more than a first upper margin.

22. The method according to claim 21, wherein at least one selectively driven alternator is selectively coupled to the synchronous electrical grid, and wherein the at least one selectively driven alternator is selectively driven by an internal combustion engine, and wherein the selectively driven alternator is operated with a fixed load or power setting when the selectively driven alternator is driven by the internal combustion engine, preferably through a fixed power setting of the internal combustion engine, the selectively driven alternator preferably being operated with a fixed load or power setting for a predetermined length of time, with the fixed load or power setting changing periodically.

23. (canceled)

24. A method for supporting a synchronous electrical grid, the synchronous electrical grid having coupled thereto:
one or more alternators powered by a non-fluctuating source of energy,
at least one fluctuating source of electric power generated from renewable energy for supplying electric power to the synchronous electrical grid,
consumers creating a fluctuating consumer electric power demand on the synchronous electrical grid,
at least one selectively driven alternator, the selectively driven alternator being selectively operably couplable to an internal combustion engine operated on hydrogen or a mixture of hydrogen and another fuel, the internal combustion engine being coupled to a hydrogen supply system, the hydrogen supply system comprising a hydrogen storage unit,
at least one hydrogen generating unit coupled to the electrical grid and/or to the at least one fluctuating source of electric power,
the method comprising:
keeping the selectively driven alternator coupled to the synchronous electrical grid and online regardless of the alternator being coupled to the internal combustion engine,
powering the at least one hydrogen generating unit (64) with electric power from the at least one fluctuating source of electric power (14) when, and preferably only when actual electric power generated by the at least one fluctuating source of electric power (14) exceeds actual consumer electric power demand and simultaneously hydrogen storage capacity is available in the hydrogen storage unit (136), for generating hydrogen with the at least one hydrogen generating unit (64),
storing hydrogen generated by the at least one hydrogen generating unit (64) in the hydrogen storage unit (136),
generating electric power with the at least one selectively driven alternator (34) by combusting hydrogen from the hydrogen storage unit (136) or a mixture of hydrogen from the hydrogen storage unit (136) and another fuel in the internal combustion engine (32) by operably coupling the internal combustion engine (32) to the alternator (34) and driving the alternator (34) with the internal combustion engine (32), when, and preferably only when actual electric power generated by the at least one fluctuating source of electric power (14) is less than the actual consumer electric power demand and simultaneously the amount of hydrogen in the hydrogen storage unit (136) is above a hydrogen amount threshold.

25. The method according to claim 24, wherein the at least one selectively driven alternator is operated with a fixed load or power setting when the selectively driven alternator is driven by the internal combustion engine, preferably through a fixed power setting of the internal combustion engine, the selectively driven alternator preferably being operated with a fixed load or power setting for a predetermined length of time, with the fixed load or power setting changing periodically.

26-43. (canceled)
